(19) United States
(12) Patent Application Publication
(10) Pub. No.: US 2020/0251867 A1
(43) Pub. Date: Aug. 6, 2020

(54) SOCKET FOR ELECTRICAL COMPONENT

(71) Applicant: ENPLAS CORPORATION, Kawaguchi-shi, Saitama (JP)

(72) Inventor: Katsuya TSUNEOKA, Kawaguchi-shi (JP)

(73) Assignee: ENPLAS CORPORATION, Kawaguchi-shi, Saitama (JP)

(21) Appl. No.: 16/636,246

(22) PCT Filed: Jul. 26, 2018
(86) PCT No.: PCT/JP2018/028045

§ 371 Date: Feb. 3, 2020

(30) Foreign Application Priority Data
Aug. 4, 2017 (JP) 2017-151379

(51) Int. Cl. H01R 33/76; H01R 13/52

(52) U.S. Cl. CPC H01R 33/7685; H01R 13/5205

(57) ABSTRACT

A socket for electrical component that can make it difficult to attach foreign matter to the top surface of the electrical component even in an open-top type. The solution is to provide a contact pin 50 which is electrically connected to a terminal 4 of the electrical component 2 in a socket body 20 having a housing portion 23 which houses the electrical component 2. A latch 40 is also provided for pressing the electrical component 2 while the electrical component 2 is closed by an opening/closing operation. An operating member 30 which activates the latch 40 is moveable up and down with respect to the socket body 20. The socket 10 is provided with a pressing portion 44, 48 which presses the electrical component 2 in the latch 40 and a covering portion 43, 47 which covers a predetermined portion 5 of the electrical component 2.

### TECHNICAL FIELD

This invention relates to a socket for electrical component that is electrically connected to an electrical component such as a semiconductor device (hereinafter referred to as an “IC package”).

### BACKGROUND ART

Conventionally, an IC socket in which contact pins are disposed is known as a socket for this type of electrical component. The IC socket is disposed on a wiring substrate and is configured to accommodate an IC package to be inspected, so that the terminals of the IC package and the electrodes of the wiring substrate are electrically connected through the contact pins to conduct tests such as electrical continuity tests.

Such an IC socket is known to be of the so-called open-top type which is open above the socket and which is configured to take in and out an IC package from above the socket. (See, e.g., Patent Document 1).

### PRIOR ART DOCUMENT

### Patent Document

Patent Document 1: Japanese Patent Laid-Open No. 2006-127936

### SUMMARY OF INVENTION

### Problems to be Solved by the Invention

However, in an open-top type IC socket such as in Patent Document 1, for example, when an IC package, which extremely dislikes to adhere foreign matter on its top surface, is housed on the top surface of the package, it is inevitable that foreign matter attaches to the top surface of the IC package because it is open-top type.

Accordingly, the present invention is challenged to provide a socket (IC socket) for electrical component that can make it difficult to adhere foreign matter to the upper surface of an electrical component (IC package) even in an open-top type.

### Means for Solving Problems

In order to solve such a problem, the invention of claim 1 is characterized in that a socket for electrical component comprising: a socket body having a housing portion for housing an electrical component, a contact pin electrically connected to a terminal of the electrical component, a latch for pressing the electrical component in a closed state while an opening/closing operation is performed, and an operating member, movable up/down with respect to the socket body, for actuating the latch,
wherein the latch is provided with a pressing portion for pressing the electrical component and a covering portion covering a predetermined portion of the electrical component.

The invention according to claim 2, in addition to the invention according to claim 1, is characterized in that the latch includes a first latch member and a second latch member that are movably disposed about an axis facing both sides of the housing portion,

the first latch member and the second latch member are provided with the pressing portion and the covering portion respectively, and

when the first latch member and the second latch member are in the closed state, a distal end portion of the covering portion of the first latch member and a distal end portion of the covering portion of the second latch member overlap so that a predetermined portion of the electrical component is covered by both of the covering portions.

The invention according to claim 3, in addition to the invention according to claim 1, is characterized in that the latch includes a first latch member and a second latch member that are movably disposed about an axis facing both sides of the housing portion,

the first latch member and the second latch member are provided with the pressing portion and the covering portion respectively, and

when the first latch member and the second latch member are in the closed state, a distal end portion of the covering portion of the first latch member and a distal end portion of the covering portion of the second latch member are in contact each other so that a predetermined portion of the electrical component is covered by both of the covering portions.

The invention according to claim 4, in addition to the invention according to claim 1, is characterized in that the latch includes a latch member body which is movably disposed about an axis with respect to the socket body and a plate member which is pivotally mounted to the latch member body, and

the plate member is provided with the pressing portion around the plate member and has the covering portion inside the pressing portion.

The invention according to claim 5, in addition to the invention according to claim 4, is characterized in that a contact portion is provided at an end of the plate member of the axis side of the latch member body,

an abutment portion configured to be inclined inward from a lower side to an upper side of the socket body is provided at a position where the contact portion contacts when the latch moves from the closed state to an open state in the opening/closing operation, and

when the latch is moved from the closed state to the open state in the opening/closing operation, the contact portion moves along the abutment portion, such that the plate member pivots with respect to the latch member body to be a rising state with respect to the socket body and the housing portion is configured to open toward upward.

The invention according to claim 6, in addition to the invention according to claim 1, is characterized in that the pressing portion of the latch is composed of a protrusion portion and is configured to surround the covering portion.

### Advantageous Effects of invention

According to the invention of claim 1, since the covering portion of the latch covers the predetermined portion of the electrical component, it is possible to make it difficult to attach foreign matter to the predetermined portion of the electrical component.

According to the invention of claim 2, since the predetermined portion of the electrical component is covered by the covering portion of the first latch member and the covering portion of the second latch member which are in overlapped each other, it is possible to cover the predetermined portion of the electrical component without any clearance, thereby making it more difficult to attach foreign matter to the electrical component.

According to the invention of claim 3, since the distal end portion of the covering portion of the first latch member and the distal end portion of the covering portion of the second latch member are in contact each other and the covering portions of the first latch member and the second latch member cover the predetermined portion of the electrical component, and therefore, the portion of the electrical component can be covered without any clearance, thereby making it more difficult to attach foreign matter to the electrical component.

According to the invention of claim 4, the latch includes the latch member body and the plate member mounted thereto, the pressing portion is provided around the plate member, and the covering portion is provided inside the latch member, therefore, it is possible to cover the predetermined portion of the electrical component without any clearance by the covering portion of the single plate member, thereby making it more difficult to attach foreign matter.

In addition, since the plate member in contact with the electrical component is rotatably mounted to the latch member body, it is possible to prevent the electrical component from being damaged by the latch, so that the plate member does not hit the electrical component at one side or rotates so as to soften a shock when the plate member comes into contact with the electrical component while the latch is closed.

According to the invention of claim 5, when the contact portion of the plate member and the abutment portion of the operating member act to open the latch, the upper portion of the housing portion can be made more open. As a result, the electrical component can be taken in and out smoothly.

According to the invention of claim 6, since the pressing portion of the latch is composed of the protrusion portion which is formed so as to surround the covering portion, the gap between the latch and the electrical component, when the electrical component is pressed by the pressing portion, can be eliminated as much as possible, thereby protecting foreign material from entering from a lateral direction into the interior.

### BRIEF DESCRIPTION OF DRAWINGS

FIG. 1 is a perspective view illustrating the closing state of the latch of the IC socket according to the first embodiment of the present invention.

FIG. 2 is a cross-sectional view of II-II of FIG. 1 of the IC socket according to the first embodiment.

FIG. 3 is a perspective view illustrating the open state of the latch of the IC socket according to the first embodiment.

FIG. 4 is a cross-sectional view of IV-IV of FIG. 3 in the IC socket according to the first embodiment.

FIG. 5 is a cross-sectional view illustrating the state between the open state and the closed state of the latch of the IC socket according to the first embodiment.

FIG. 6 is a plan view illustrating a first latch member in the IC socket according to the first embodiment.

FIG. 7 is a right side view illustrating the first latch member in the IC socket according to the first embodiment.

FIG. 8 is a rear view illustrating the first latch member in the IC socket according to the first embodiment.

FIG. 9 is a front view illustrating a first latch member in the IC socket according to the first embodiment.

FIG. 10 is a cross-sectional view of X-X of FIG. 6 of the first latch member in the IC socket according to the first embodiment.

FIG. 11 is a plan view illustrating a second latch member in the IC socket according to the first embodiment.

FIG. 12 is a right side view illustrating the second latch member in the IC socket according to the first embodiment.

FIG. 13 is a rear view illustrating the second latch member in the IC socket according to the first embodiment.

FIG. 14 is a front view illustrating the second latch member in the IC socket according to the first embodiment.

FIG. 15 is a cross-sectional view of the XV-XV of FIG. 11 of the second latch member in the IC socket according to the first embodiment.

FIG. 16 is a plan view illustrating the IC package used in the first embodiment;

FIG. 17 is a side view of the IC package used in the first embodiment.

FIG. 18 is a perspective view illustrating the closing state of the latch of the IC socket according to the second embodiment of the present invention.

FIG. 19 is a cross-sectional view of XIX-XIX of FIG. 18 in the IC socket according to the second embodiment.

FIG. 20 is a perspective view illustrating the open state of the latch of the IC socket according to the second embodiment.

FIG. 21 is a cross-sectional view of XXI-XXI of FIG. 20 in the IC socket according to the second embodiment.

FIG. 22 is a partially enlarged cross-sectional view of FIG. 19 in the IC socket according to the second embodiment.

FIG. 23 is a plan view illustrating a first latch member of the IC socket according to the second embodiment.

FIG. 24 is a right side view illustrating the first latch member in the IC socket according to the second embodiment.

FIG. 25 is a rear view illustrating the first latch member in the IC socket according to the second embodiment.

FIG. 26 is a front view illustrating a first latch member in the IC socket according to the second embodiment.

FIG. 27 is a cross-sectional view of XXVII-XXVII of FIG. 23 of the first latch member in the IC socket according to the second embodiment;

FIG. 28 is a perspective view illustrating the closing state of the latch of the IC socket according to the third embodiment of the present invention.

FIG. 29 is a cross-sectional view of XXIX-XXIX of FIG. 28 in the IC socket according to the third embodiment.

FIG. 30 is a perspective view illustrating the open state of the latch of the IC socket according to the third embodiment.

FIG. 31 is a cross-sectional view of the XXI-XXXI of FIG. 30 in the IC socket according to the third embodiment.

FIG. 32 is a partially enlarged cross-sectional view of FIG. 29 in the IC socket according to the third embodiment.

FIG. 33 is a perspective view illustrating the latch in the IC socket according to the third embodiment.

FIG. 34 is a plan view illustrating a latch member body of the IC socket according to the third embodiment.

FIG. 35 is a right side view illustrating the latch member body of the IC socket according to the third embodiment.

FIG. 36 is a rear view illustrating the latch member body of the IC socket according to the third embodiment.

FIG. 37 is a front view illustrating the latch member body of the IC socket according to the third embodiment.

FIG. 38 is a cross-sectional view of XXVIII-XXXVIII of FIG. 34 of the latch member body of the IC socket according to the third embodiment.

FIG. 39 is a plan view illustrating a plate member in the IC socket according to the third embodiment.

FIG. 40 is a right side view illustrating the plate member in the IC socket according to the third embodiment.

FIG. 41 is a rear view illustrating the plate member in the IC socket according to the third embodiment.

FIG. 42 is a front view illustrating the plate member in the IC socket according to the third embodiment.

FIG. 43 is a cross-sectional view of XXXIII-XXXXIII of FIG. 39 of the plate member in an IC socket according to the third embodiment.

FIG. 44 is a cross-sectional perspective view illustrating the closing state of the latch in the IC socket according to the fourth embodiment of the present invention.

FIG. 45 is a cross-sectional view illustrating a state between the open state and the closed state of the latch of the IC socket according to the fourth embodiment.

FIG. 46 is a cross-sectional view illustrating the state between the open state and the closed state of the latch of the IC socket according to the fourth embodiment.

FIG. 47 is a cross-sectional view illustrating the state between the open state and the closed state of the latch of the IC socket according to the fourth embodiment.

FIG. 48 is a cross-sectional view illustrating the open state of the latch of the IC socket according to the fourth embodiment.

### DESCRIPTION OF EMBODIMENTS

Hereinafter, embodiments of the present invention will be described.

### Embodiment 1 of the Invention

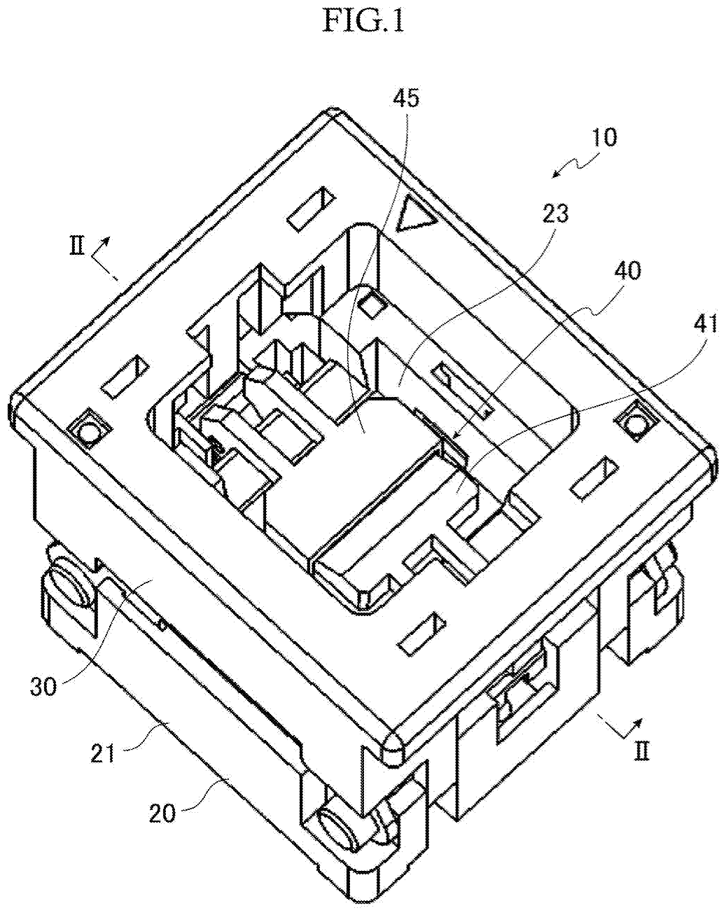

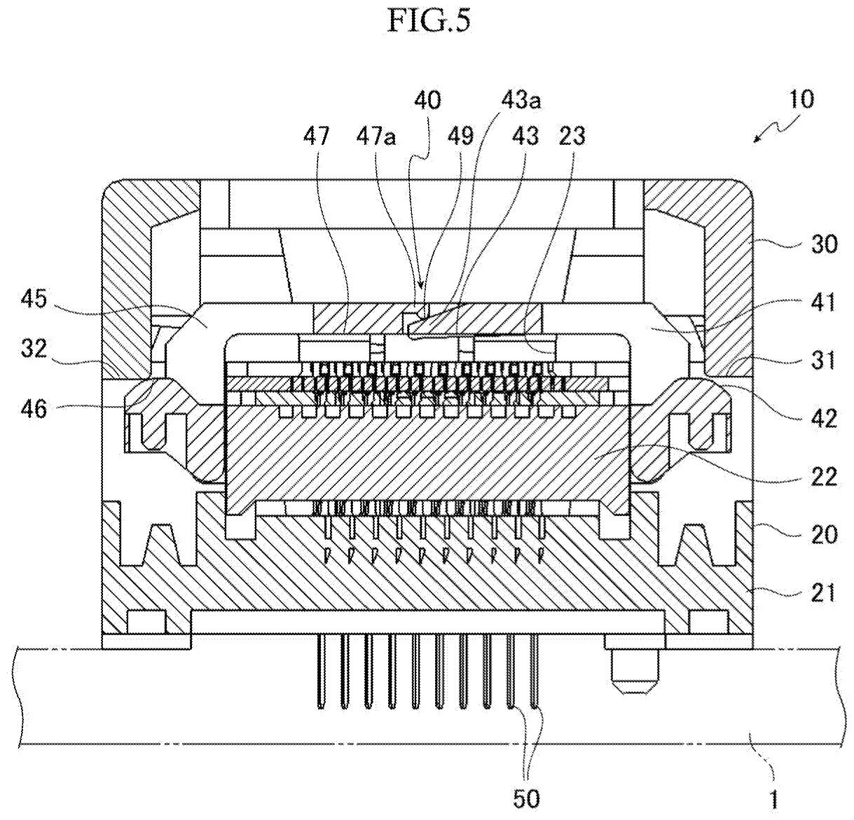

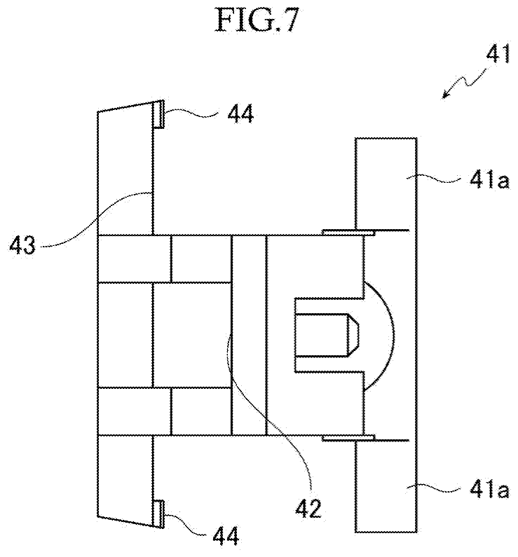

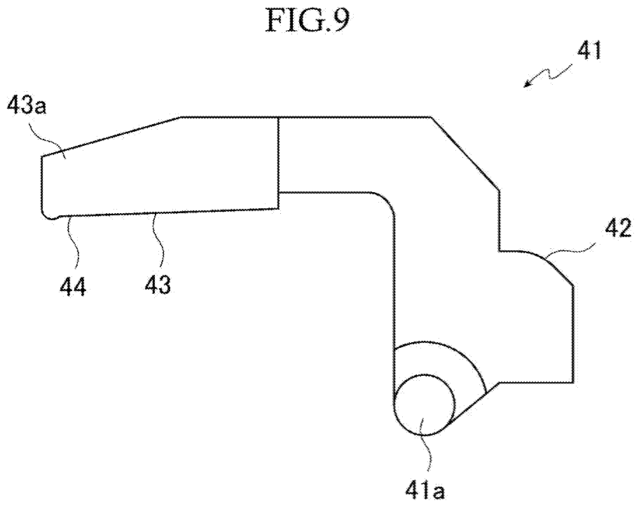

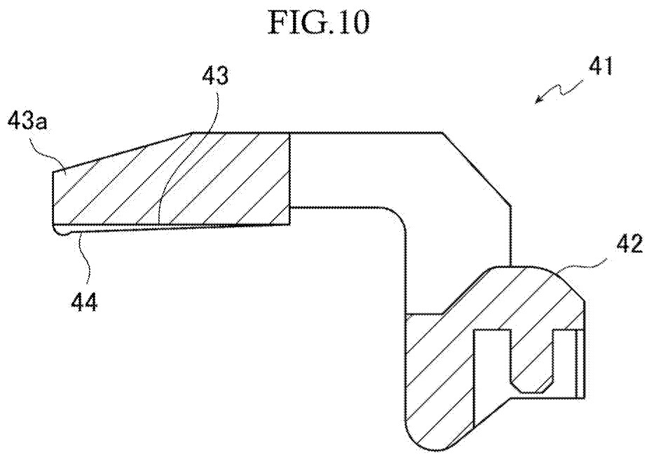

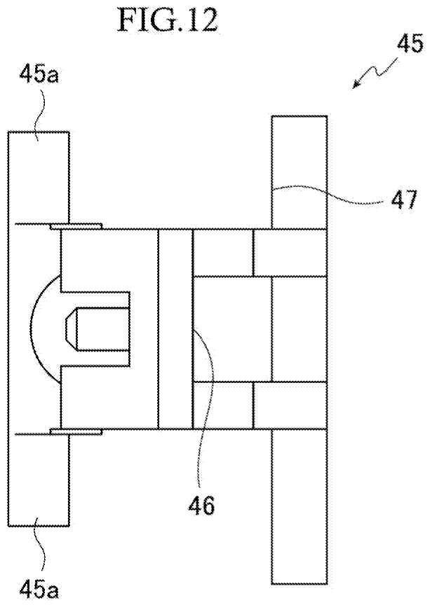

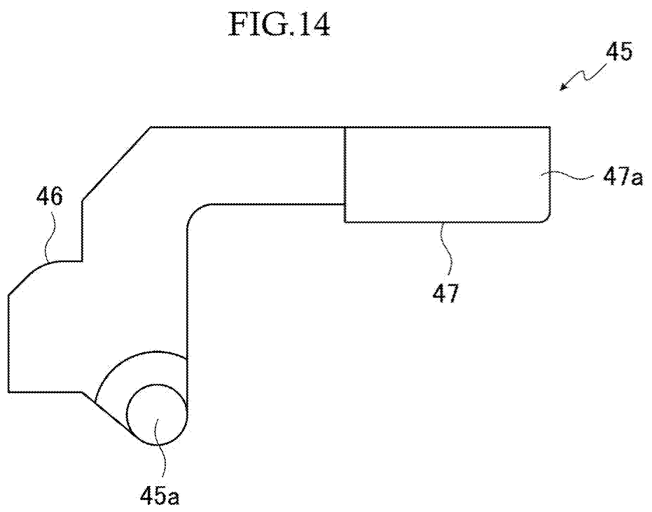

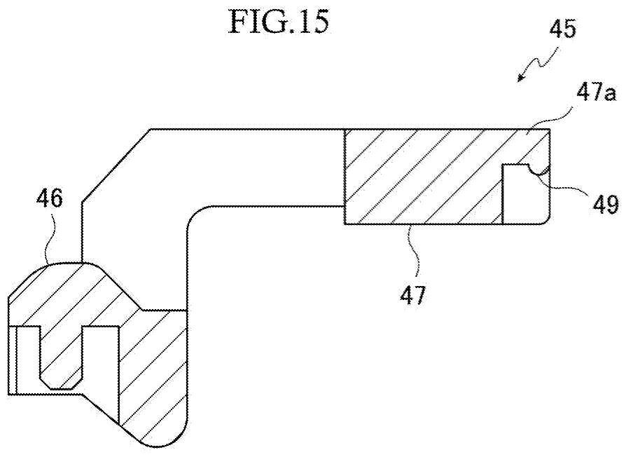

FIGS. 1-17 show embodiment 1 of the present invention.

The IC socket 10 as a “socket for electrical component” of this embodiment is disposed on the wiring substrate 1 as shown in FIGS. 1 to 4, and the IC package 2 as an “electrical component” is accommodated on the top thereof, and is configured to contact an electrode of a wiring substrate 1 (not shown) and a solder ball 4 as a “terminal” of the IC package 2 to electrically connect the two. The IC socket 10 is used, for example, in a test device for electrical continuity testing, such as a burn-in test for the IC package 2.

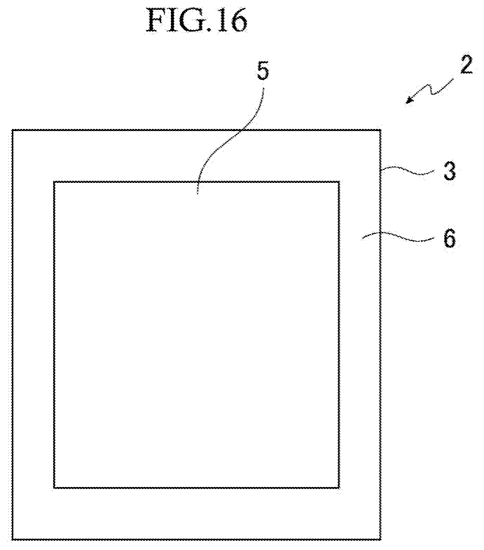

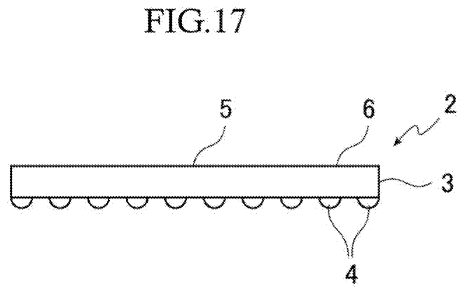

The IC package 2 of this embodiment is provided with a plurality of spherical solder balls 4 in a matrix shape within a predetermined range of the substantially rectangular shape of the lower surface of the substantially rectangular-shaped package body 3, as shown in FIGS. 16 and 17

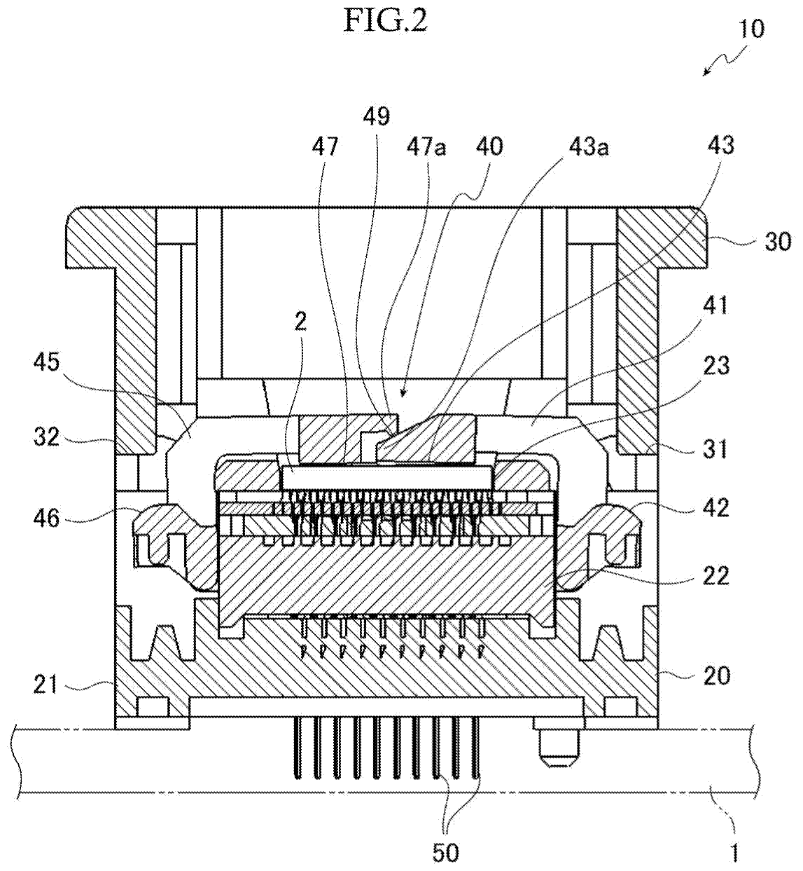

The IC socket 10 also includes a socket body 20 disposed on the wiring substrate 1 and configured to accommodate the IC package 2, as shown in FIG. 2. The socket body 20 is provided with a contact pin 50 which contacts the solder balls 4 of the IC package 2, and a latch 40 which holds the IC package 2 in a closed state (hereinafter referred to as the “closed state”) while performing an opening/closing operation. An operation member 30 is disposed above the socket body 20 to operate the opening and closing operation of the latch 40 by moving the socket up and down.

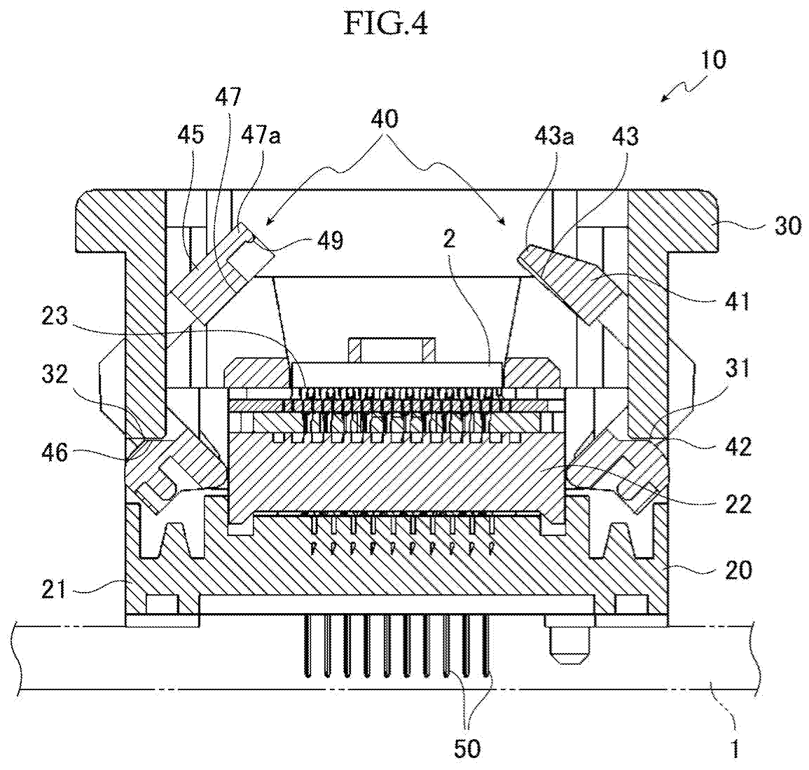

In particular, as shown in FIG. 4, the socket body 20 exhibits a planar visual square shape, and a contact module 22 is disposed above the base 21, and includes a housing portion 23 for accommodating the IC package 2 on the top surface of the contact module 22. In addition, a plurality of contact pins 50 are disposed to penetrate the housing portion 23, the contact module 22, and the base 21. The contact pin 50 is configured to contact the solder ball 4 of the IC package 2, the upper end of which is contained in the housing portion 23, and the lower end of which is in contact with the electrode of the wiring substrate 1 to conduct both.

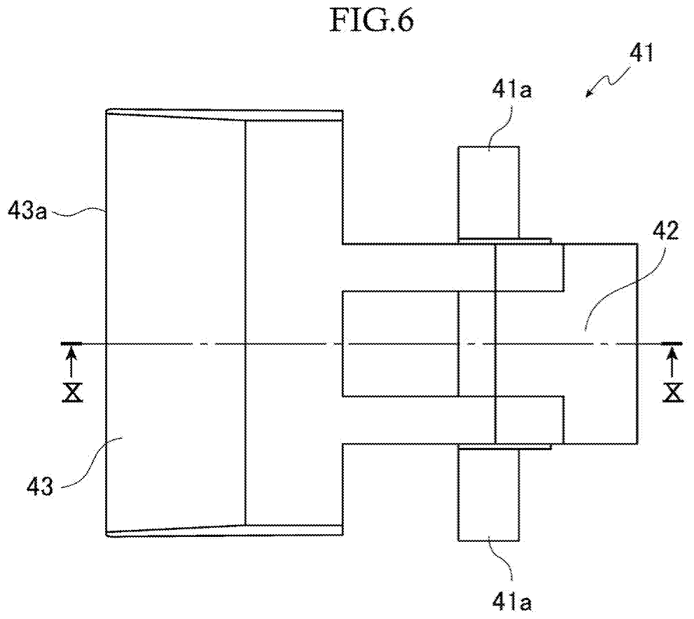

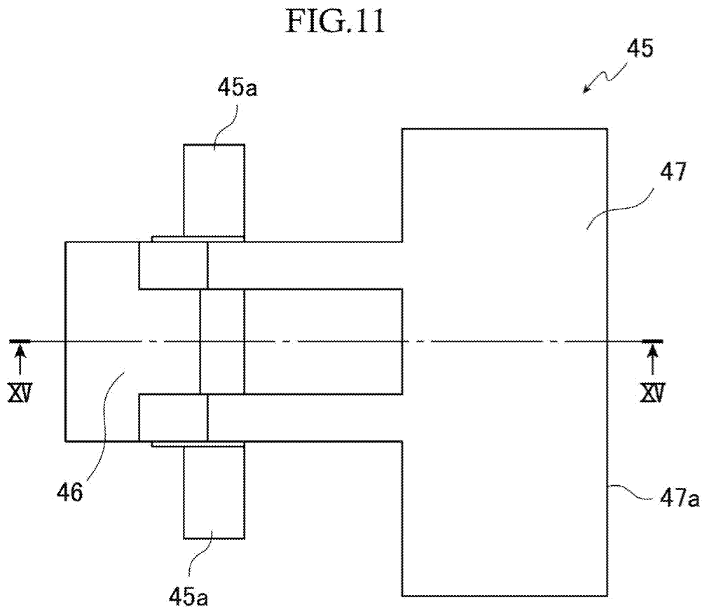

The socket body 20 is provided with a latch 40. As shown in FIGS. 1-5, the latch 40 of this embodiment is configured so that the first latch member 41 as shown in FIGS. 6-10 and the second latch member 45 as shown in FIGS. 11-15 are disposed in a position facing both sides of the housing portion 23. In response to the vertical movement of the operating member 30 described below, the first latch member 41 and the second latch member 45 pivot about the shafts 41a and 45a that are engaged in a predetermined position of the socket body 20 to perform the opening/closing operation. The first latch member 41 and the second latch member 45 are configured to open (hereinafter referred to as the opening state) and close the housing portion 23.

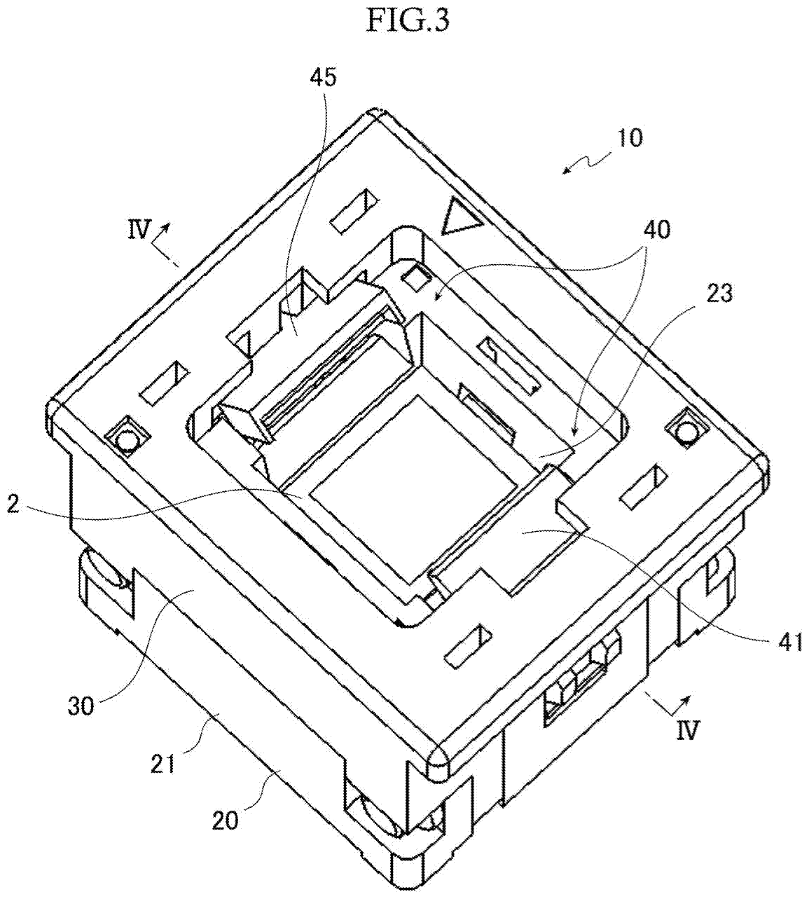

Namely, both the first latch member 41 and the second latch member 45 are biased in a direction in which the first latch member 41 and the second latch member 45 are rotated inwardly by an biasing force. As shown in FIGS. 1 and 2, the first latch member 41 and the second latch member 45 are closed in a state in which the IC package 2 housed in the housing portion 23 is pressed. As shown in FIGS. 3 and 4, the first latch member 41 and the second latch member 45 are turned outward against the biasing force, and the first latch member 41 and the second latch member 45 are opened in a state in which the IC package 2 can be received in the housing portion 23 or the pressure of the IC package 2 contained in the housing portion 23 can be removed and the IC package 2 can be taken out from the pushing force of the IC package 2.

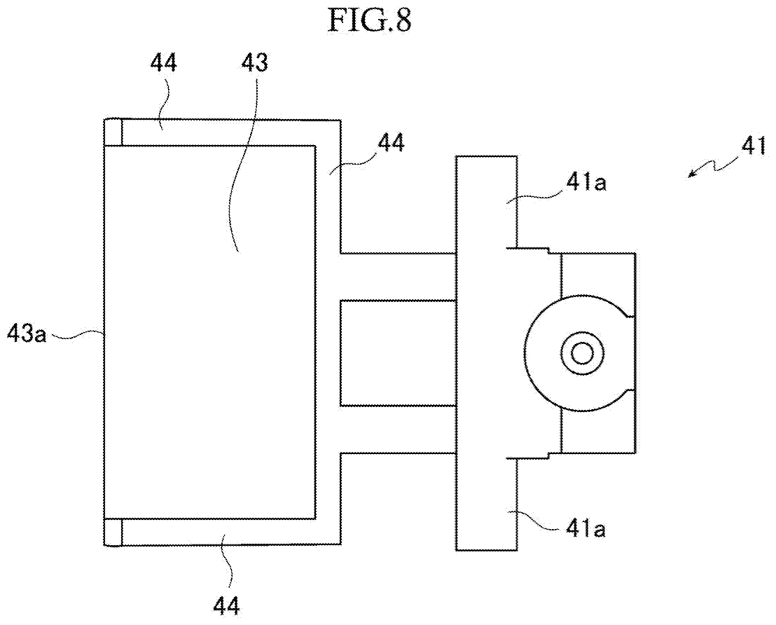

Further, as illustrated in FIGS. 6 to 10, a plate shaped covering portion 43 is provided in the first latch member 41. When the first latch member 41 is closed as illustrated in FIGS. 1 and 2, the covering portion 43 is configured to cover about half of the upper surface 5 of the package of the IC package 2 with a predetermined clearance and without touching it. Further, a protrusion portion 44 as a “pressing portion” is provided around the covering portion 43. Here, as shown in FIG. 8, a substantially U-shaped protrusion portion 44 formed continuously protrudes downwardly so as to cover a circumference other than the tip portion 43a of the covering portion 43 without any clearance. The protrusion portion 44 are configured to abut the resin member 6 around the upper surface 5 of the package in the IC package 2.

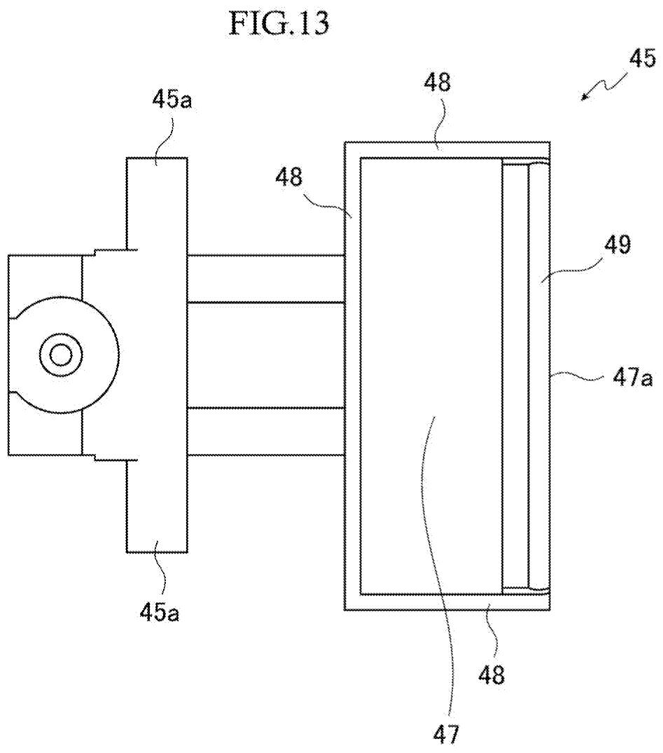

Further, as illustrated in FIGS. 11 to 15, a plate shaped covering portion 47 is also provided in the second latch member 45. When the second latch member 45 is closed as illustrated in FIGS. 1 and 2, the covering portion 47 is configured to cover about half of the upper surface 5 of the package of the IC package 2, which is not covered by the covering portion 43, with a predetermined clearance and without touching it. A protrusion portion 48 as a “pressing portion” is provided around the covering portion 47. Here, as shown in FIG. 13, a substantially U-shaped protrusion portion 48 formed continuously protrudes downwardly so as to cover a circumference other than the tip portion 47a of the covering portion 47 without any clearance.

The protrusion portion 44 of the first latch member 41 and the protrusion portion 48 of the second latch member 45 are configured to cover the covering portions 44 and 47 in a square shape.

Further, as illustrated in FIGS. 2, 4, and 5, the second latch member 45 is provided with a contact portion 49 which protrudes continuously downwardly wholly from one end to the other end of the tip portion 47a. When the latch 40 is closed, the contact portion 49 is configured to be locked to the inclined upper surface of the tip portion 43a of the first latch member 41 and the first latch member 41 and the second latch member 45 engage in a state where the first latch member 41 and the second latch member 45 overlap each other. When the first latch member 41 and the second latch member 45 overlap each other, the gap between the first latch member 41 and the second latch member 45 is blocked by the contact portion 49, and the respective protrusion portions 44 and 48 contact the resin member 6 of the IC package 2 without any clearance, so that the upper surface 5 of the substantially central portion of the IC package 2 is covered with a predetermined clearance by the covering portions 43 and 47.

A frame-shaped operating member 30 is disposed above the socket body 20 so as to move up and down with respect to the socket body 20, and is configured so as to be biased upwardly with respect to the socket body 20 by a biasing means not shown.

In addition, as illustrated in FIGS. 2, 4, and 5, a predetermined shape of pushing portions 31, 32 are disposed at the lower portion of the operating member 30. The pushing portions 31 and 32 are disposed in a position in which pushed portions 42 and 46 of the first latching member 41 and the second latching member 45 come into contact with each other from an upper side. The pushing portions 31 and 32 are pushed down in contact with the pushed portions 42 and 46 in a state in which the pushing portions 31 and 32 come into contact with the pushed portions 42 and 46 in order to open the first latching member 41 and the second latching member 45 by rotating the first latching member 41 and the second latching member 45 outward about the shafts 41a and 45a against the biasing forces of the biasing means of the first latching member 41 and the second latching member 45.

Further, since the operating member 30 is upwardly biased to the socket body 20 by the biasing means not shown, when the operating member 30 is released from pushing downward, the operating member 30 is upwardly biased, so that the pushing portions 31 and 32 are spaced apart from the pushed portions 42 and 46. As a result, the first latching member 41 and the second latching member 45 are rotated inwardly about the shafts 41a and 45a by the biasing force of the first latching member 41 and the second latching member 45, so that the first latching member 41 and the second latching member 45 are closed.

Further, as illustrated in FIGS. 2, 4, and 5, the pushing portions 31 and 32 of the operating member 30 are configured to have different lengths. The timing of contact between the pushed portion 42 of the first latching member 41 and the pushing portion 31 of the operating member 30 and the timing of contact between the pushed portion 46 of the second latching member 45 and the pushing portions 32 of the operating member 30 are not simultaneous. When the operating member 30 is pushed, the pushing portion 32 of the operating member 30 first comes into contact with the pushed portion of the second latching member 45 to start pushing. Thereafter, the pushing portion 31 of the operating member 30 comes into contact with the pushed portion 42 of the first latching member 41 to start pushing. By taking the time lag like this, as shown in FIG. 4, the second latch member 45 first releases the pressure of the IC package 2, and then the first latch member 41 releases the pressure of the IC package 2 and the upper portion of the housing portion 23 is smoothly opened.

Since the timing when the pushed portion 42 of the first latch member 41 and the pushing portion 31 of the operating member 30 are separated from each other and the timing when the pushed portion 46 of the second latch member 45 and the pushing portion 32 of the operating member 30 are separated from each other are not simultaneous, when the pushing of the operating member 30 is released, the pushing portion 31 of the operating member 30 is first separated from the pushed portion 42 of the first latch member 41 to start releasing the pushing, and thereafter, the pushing portion 32 of the operating member 30 is separated from the pushed portion 46 of the second latch member 45 to start releasing the pushing. By taking the time lag like this, as shown in FIG. 2, the IC package 2 is first pressed by the first latch member 41, and the IC package 2 and the first latch member 41 are pressed by the second latch member 45 so as to overlap the first latch member 41, so that the IC package 2 is smoothly pressed.

Next, the operation of the IC socket 10 of such a configuration will be described.

First, as shown in FIGS. 3 and 4, the operating member 30 is pressed against the biasing means to rotate the first latch member 41 and the second latch member 45 outward in the order of the second latch member 45 and the first latch member 41 to open the housing portion 23, and the IC package 2 is received in the housing portion 23 by an automatic machine or the like not shown.

Next, the pressing force of the operating member 30 is released and the operating member 30 is moved upward by the biasing force of the biasing means. Then, the first latch member 41 and the second latch member 45 rotate in the order of the first latch member 41 and the second latch member 45 by the biasing force of the biasing means of the first latch member 41 and the second latch member 45 to press the IC package 2.

In this case, each of the protrusion portions 44 and 48 abuts the resin member 6 in the IC package 2 and presses the IC package 2 with a predetermined force. In addition, since the upper surface 5 of the package is covered with overlapping covering portions 43 and 47, it is possible to prevent foreign matter from adhering to the upper surface 5 even in an open-top type. Further, by closing the tip 43a of the first latch member 41 and the tip 47a of the second latch member 45 without any clearance at the contact portion 49, it is possible to more reliably prevent foreign matter from adhering to the top. Furthermore, since the protrusion portions 44 and 48 of the first latch member 41 and the second latch member 45 are arranged continuously in a rectangular shape without clearance, the upper surface 5 is cut off from the lateral outside air to prevent foreign matter from entering the lateral direction while the protrusion portions 44 and 48 of the first latch member 41 and the second latch member 45 contact the resin member 6 of the IC package 2.

In this manner, the test is performed with the upper surface 5 securely prevented from being exposed to foreign matter, and after the test, the operating member 30 is pushed down again to release the pressure of the IC package 2 by the latch 40, and the upper portion of the housing portion 23 is opened, and the IC package 2 is removed by an automatic machine or the like under the state.

According to this embodiment, the covering portions 43 and 47 provided in the latch 40 cover the upper surface 5 of the IC package 2, so that it is difficult to attach foreign matter to the upper surface 5 of the IC package 2.

According to this embodiment, the covering portions 43 and 47 of the latch 40 cover the upper surface 5 in the IC package 2, so that the IC package 2, which is extremely averse of foreign material deposition on the upper surface 5, can be protected from foreign material by the covering portions 43 and 47. In addition, since the protrusion portions 44 and 48 as the pressing portions of the latch 40 push the portion of the resin member 6 in the IC package 2, the protrusion portions 44 and 48, which are susceptible to force applied to the IC package 2, do not push the upper surface 5, so that the protrusion portions 44 and 48 do not scratch the upper surface 5 of the IC package 2.

Further, according to this embodiment, since the upper surface 5 of the IC package 2 is covered with the covering portions 43 and 47, which are overlapping each other, of the two first latch member 41 and the second latch member 45, it is possible to cover the upper surface 5 of the IC package 2 without any clearance, thereby making it more difficult to attach foreign matter to the upper surface 5.

Further, according to the present embodiment, the pressing portion of the latch 40 is composed of the protrusion portions 44 and 48 and is formed so as to surround the enclosures 43 and 47. Therefore, the gap between the latch 40 and the IC package 2 when the IC package 2 is pressed by the pressing portion can be eliminated as much as possible, thereby protecting the foreign material from entering the IC package 2 from a lateral direction.

### Embodiment 2 of the Invention

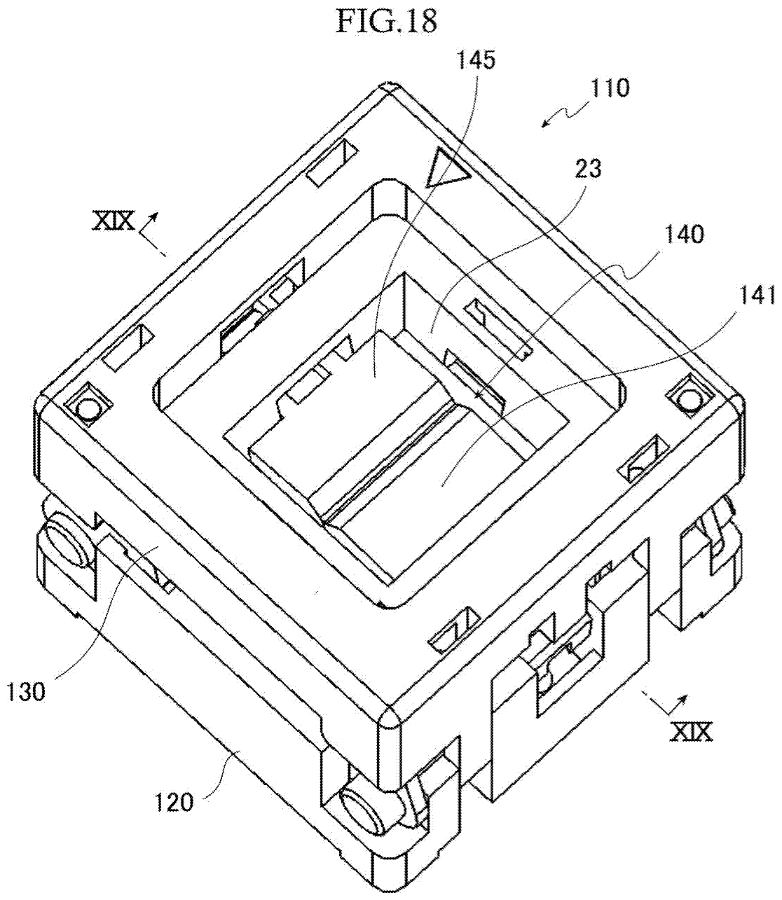

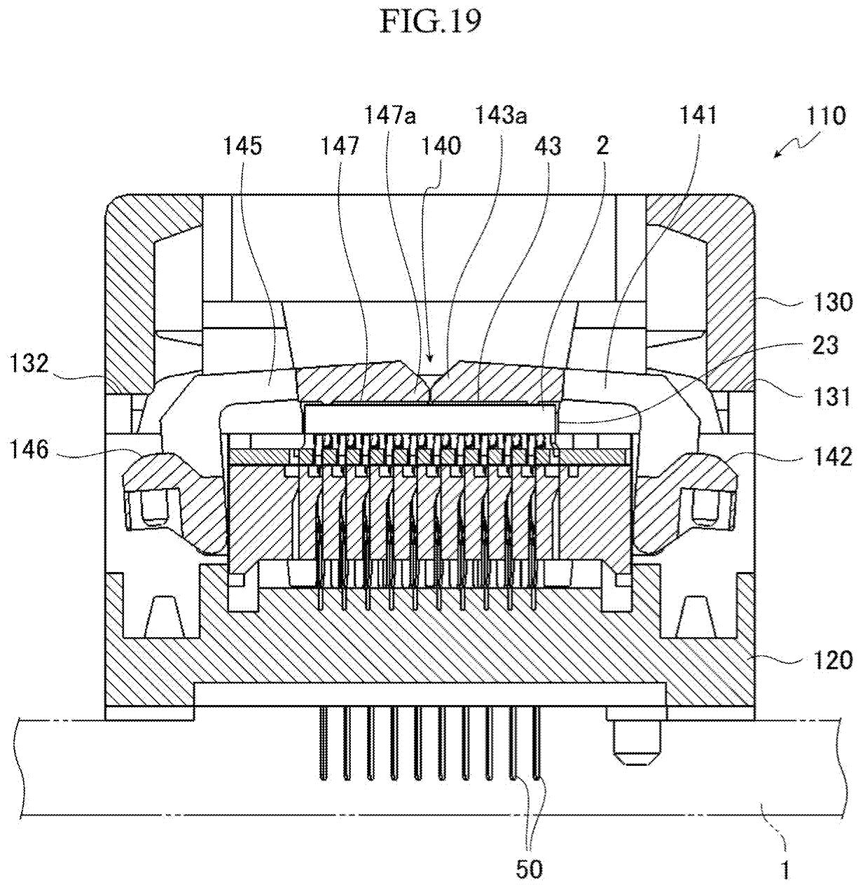

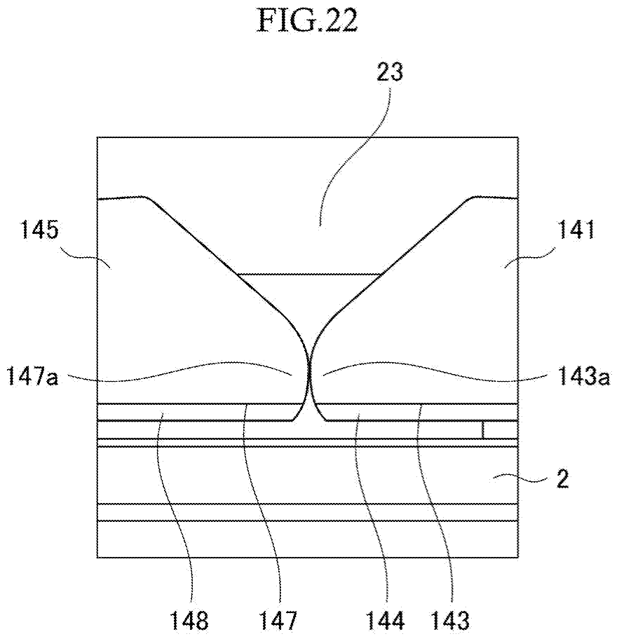

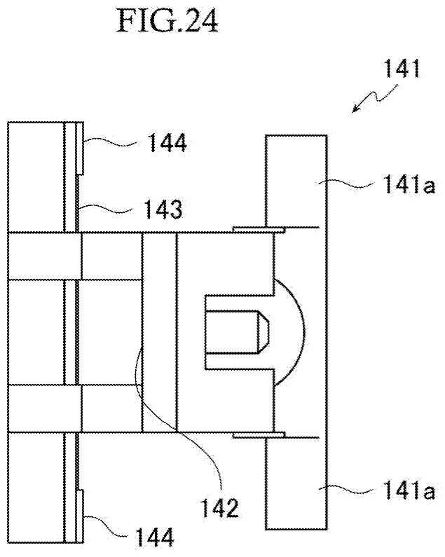

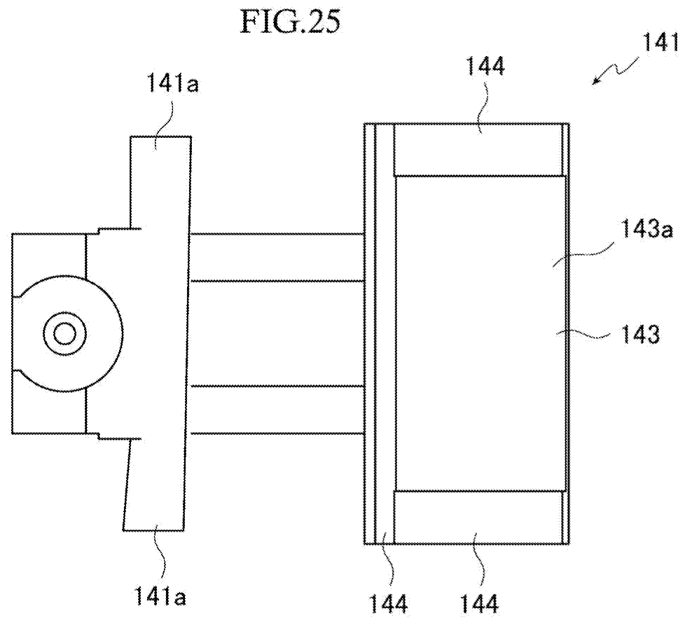

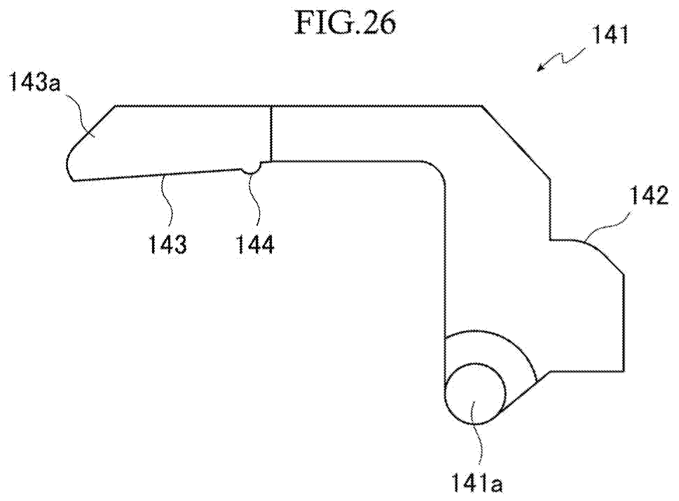

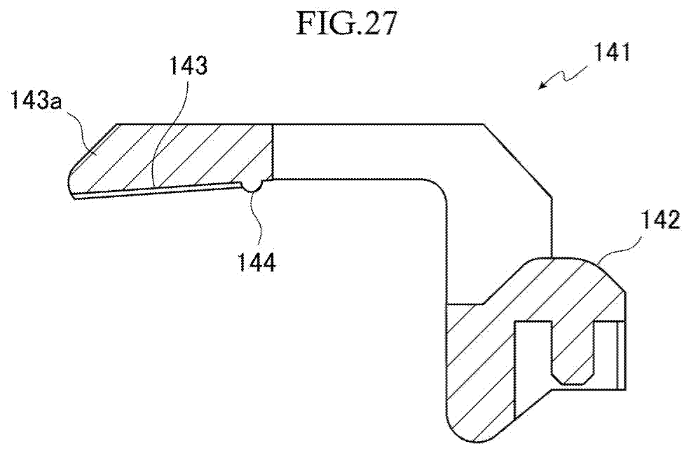

FIGS. 18-27 show embodiment 2 of the present invention. Since the embodiment of the present invention are the same as those of the above-described first embodiment except for the matters described below, the description is omitted except for matters that are different from the above described first embodiment.

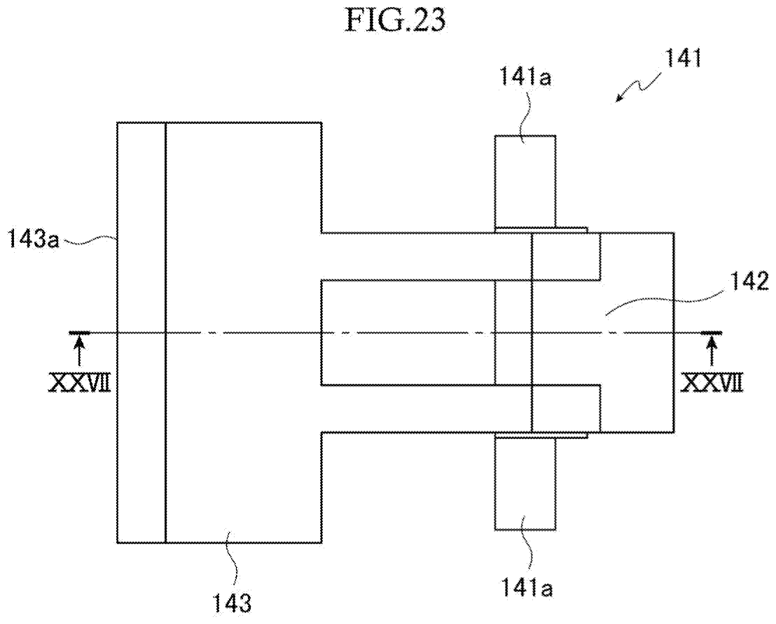

A latch 140 is provided in the socket body 120 of the IC socket 110. As shown in FIGS. 18 to 22, the latch 140 of this embodiment is configured so that the first latch member 141, as shown in FIGS. 23 to 27, and the second latch member 145, which is in a similar shape and opposite to the left and right, are disposed in a position facing both sides of the housing portion 23. When the latch 140 is closed, the tips 143a and 147a of the first latch member 141 and the second latch member 145 come into contact with each other so as not to create a gap with respect to the upper side of the covering portions 143 and 147. Since the configuration of the first latch member 141 and the second latch member 145 is the same, only the first latch member 141 is shown in detail.

In this embodiment, the length of the pushing portions 131 and 132 provided in the lower portion of the operating member 130 is the same, and the contact timing of the pushed portion 142 of the first latching member 141 and the pushing portion 131 of the operating member 130 and the contact timing of the pushed portion 146 of the second latching member 145 and the pushing portion 132 of the operating member 130 are configured to be simultaneously. Further, the tips of the first latch member 141 and the second latch member 145 are rounded to each other, so that both sides can contact each other smoothly.

Next, the operation of the IC socket 110 of such configuration will be described.

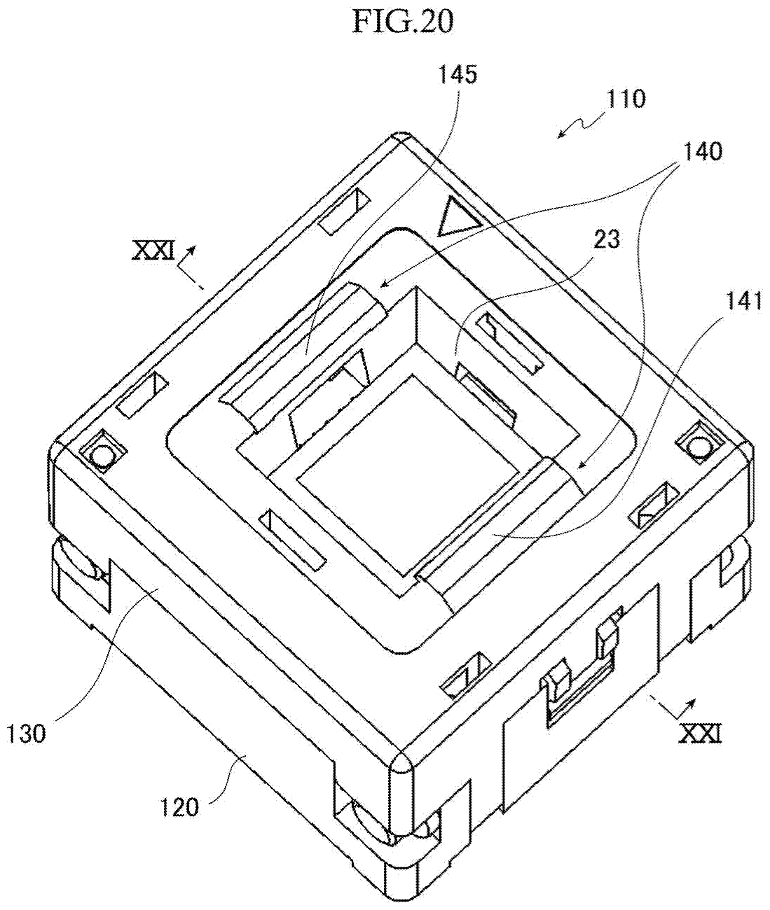

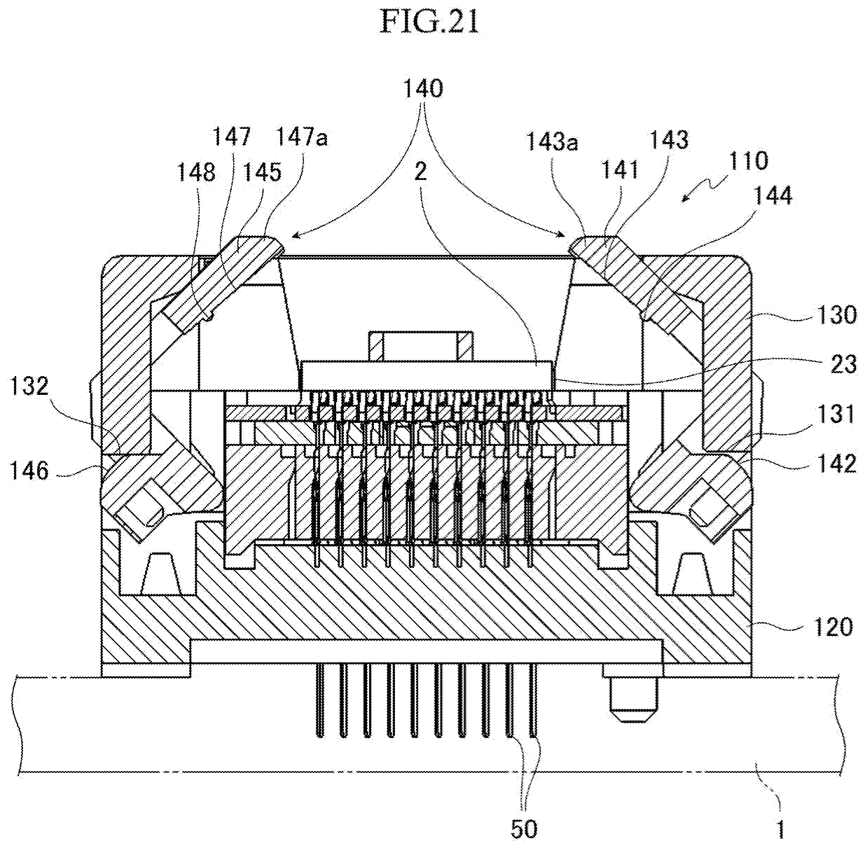

First, as illustrated in FIGS. 20 and 21, the operating member 130 is pushed down against the biasing means to rotate the first latch member 141 and the second latch member 145 outward at the same time to open the housing portion 23, and the IC package 2 is received in the housing portion 23 by an automatic machine or the like not shown.

Next, the pressing force of the operating member 130 is released and the operating member 130 is moved upward by the biasing force of the biasing means. Then, the first latch member 141 and the second latch member 145 are rotated simultaneously by the biasing force of the first latch member 141 and the second latch member 145 to push the IC package 2. At this time, since the tips of the first latch member 141 and the second latch member 145 are rounded to be round-shaped, both of them are in contact with each other smoothly, and a state in which there is no clearance can be formed between the tips of the first latch member 141 and the second latch member 145.

In this manner, the test is performed with the upper surface 5 of the package securely prevented from being exposed to foreign matter, and after the test, the operating member 130 is pushed down again to release the pressure of the IC package 2 by the latch 140, and the upper portion of the housing portion 23 is opened, and the IC package 2 is removed by an automatic machine or the like under the state.

According to this embodiment, since the covering portions 143 and 147 provided in the latch 140 cover the upper surface 5 of the IC package 2, it is possible to prevent foreign matter from being attached to the upper surface 5 of the IC package 2.

In addition, according to this embodiment, the covering portions 143 and 147 of the latch 140 cover the upper surface 5 of the IC package 2, so that the covering portions 143 and 147 of the latch 140 can protect the IC package 2, which are extremely averse of foreign matter deposition on the upper surface 5 of the IC package 2, from foreign matter by the covering portions 143 and 147. In addition, since the protrusion portions 144 and 148 as the pressing portions of the latch 140 push the portions of the resin member 6 in the IC package 2, the protrusion portions 144 and 148, which are subject to force against the IC package 2, do not push the upper surface 5 of the package, so that the protrusion portions 144 and 148 do not scratch the upper surface 5 of the package.

Further, according to this embodiment, since the upper surfaces 5 of the IC package 2 are covered with the covering portions 143, 147 of the two opposing first latch member 141 and the second latch member 145 at the state that the tips 143a and 147a of the covering portions 143, 147 of the first latch member 141 and the second latch member 145 are in contact with each other, the upper surface 5 of the IC package 2 can be covered without any clearance, thereby making it more difficult to attach foreign matter to the package.

Further, according to this embodiment, the pressing portions of the latch 140 are provided with the protrusion portions 144 and 148 and are formed so as to surround the covering portions 143 and 147. Therefore, the gap between the latch 140 and the IC package 2 when the IC package 2 is pressed by the pressing portions can be eliminated as much as possible, thereby protecting the foreign material from entering the IC package 2 from a lateral direction.

### Embodiment 3 of the Invention

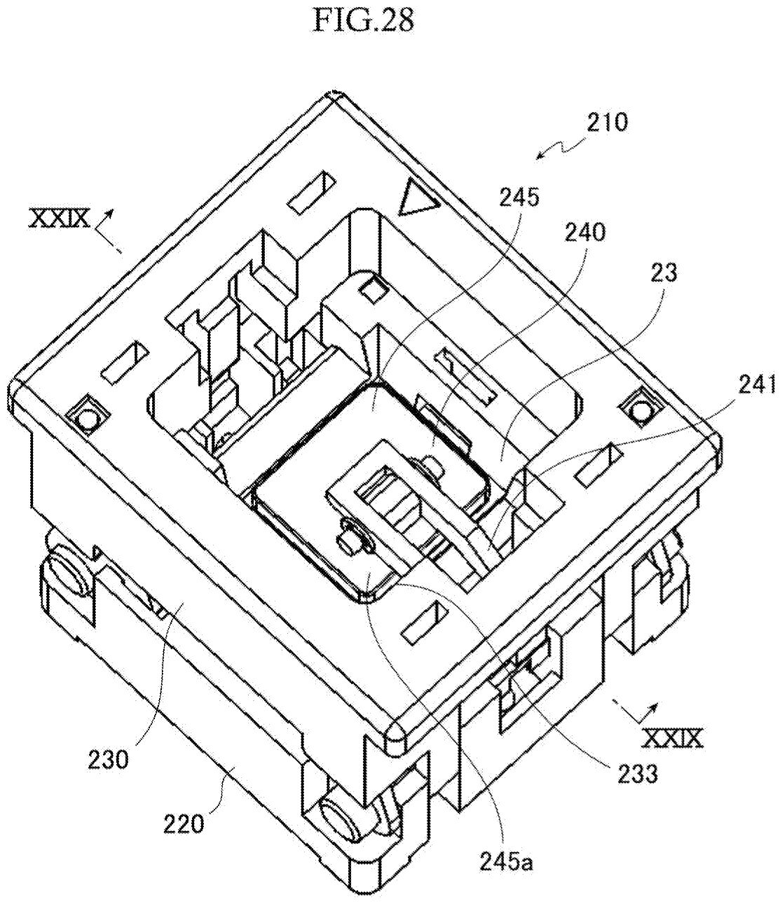

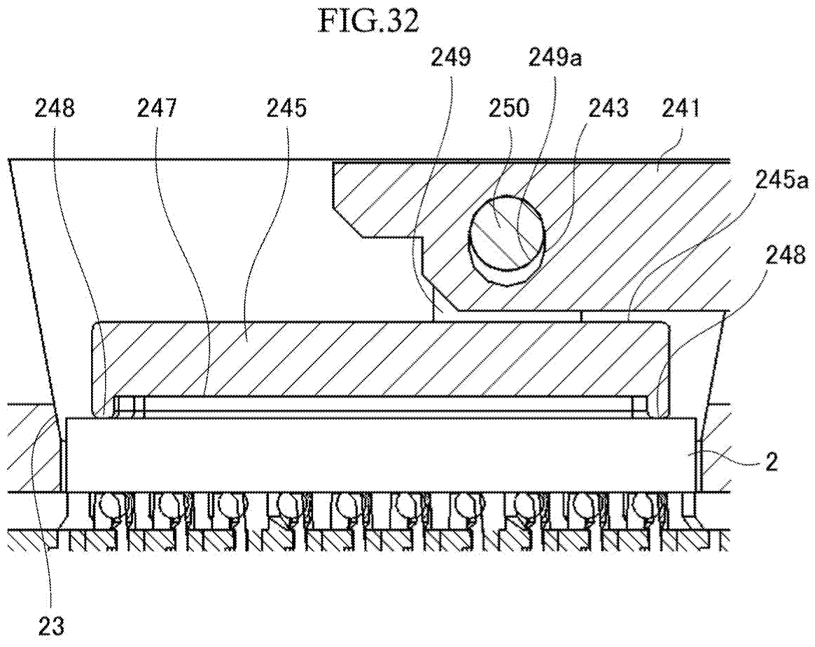

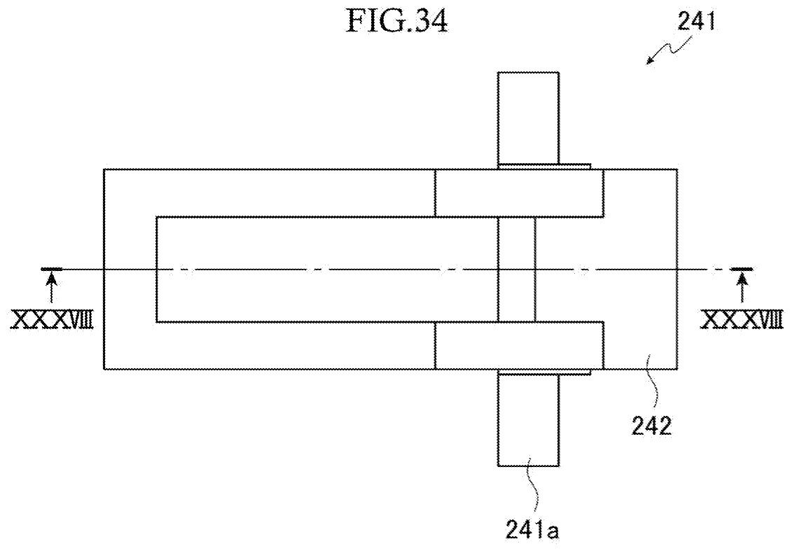

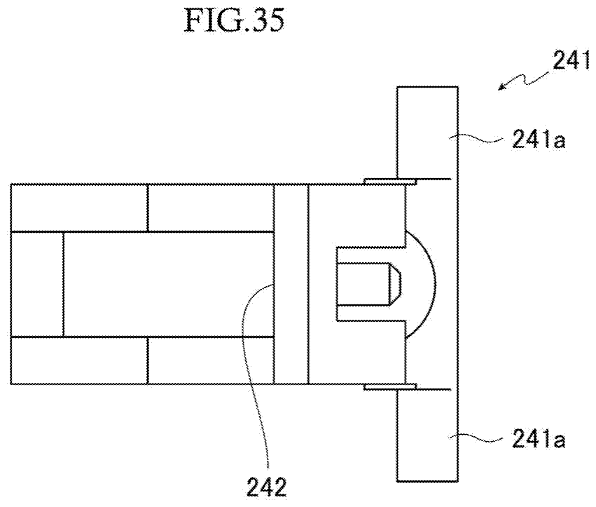

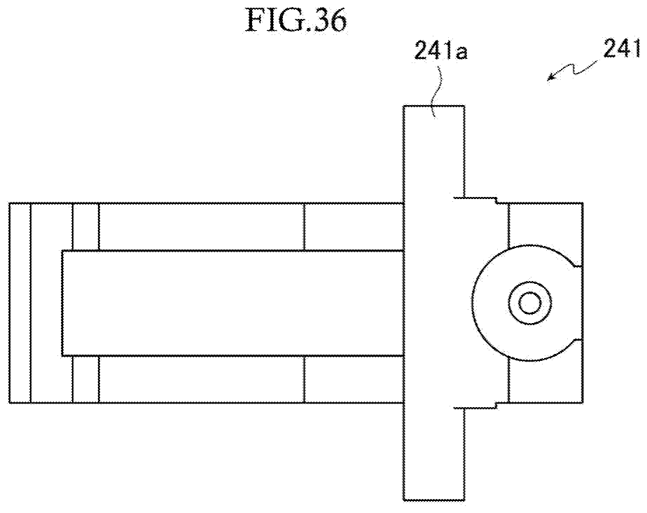

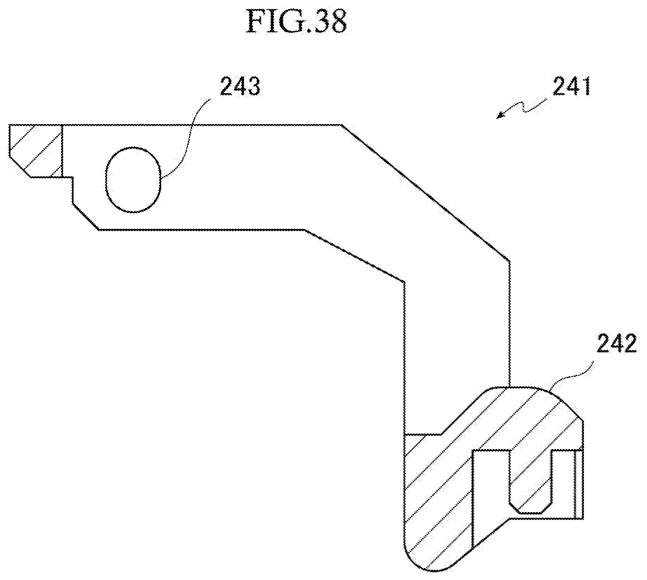

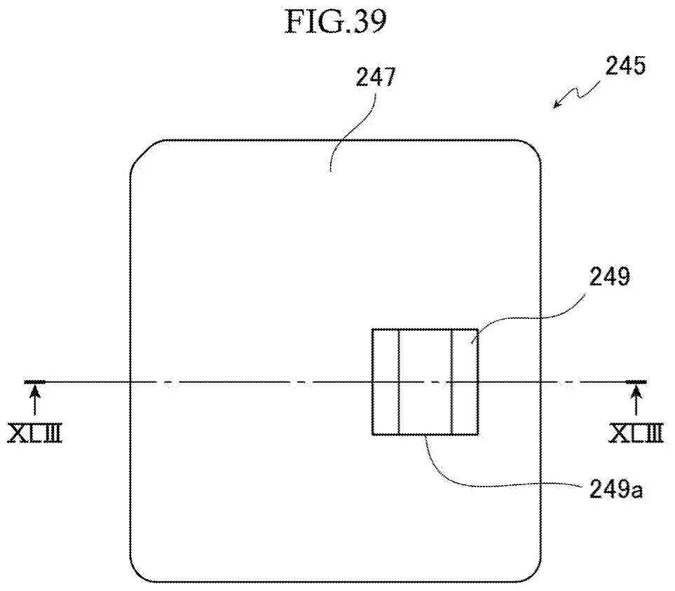

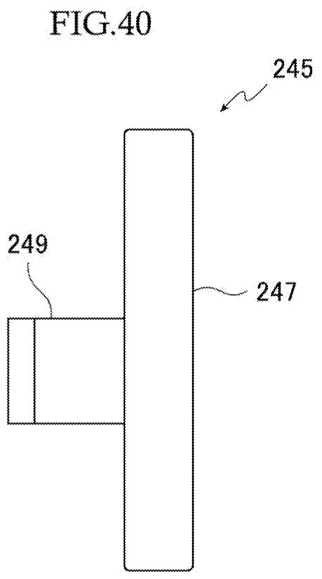

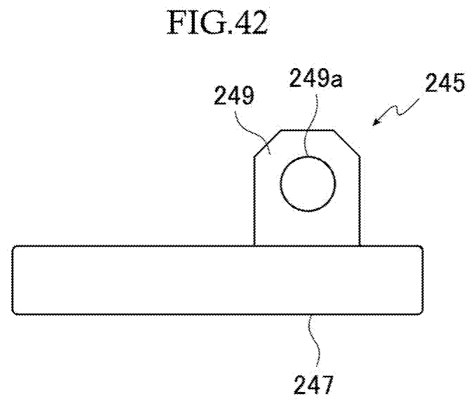

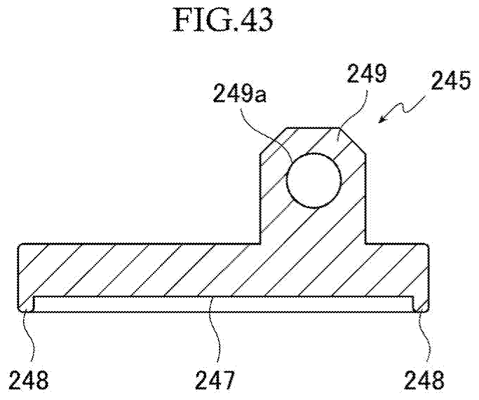

FIGS. 28-43 show embodiment 3 of the present invention. Since the embodiment of the present invention is the same as that of the above-described embodiment 1 except for the matters described below, the description is omitted except for matters that are different from the above-described embodiment 1.

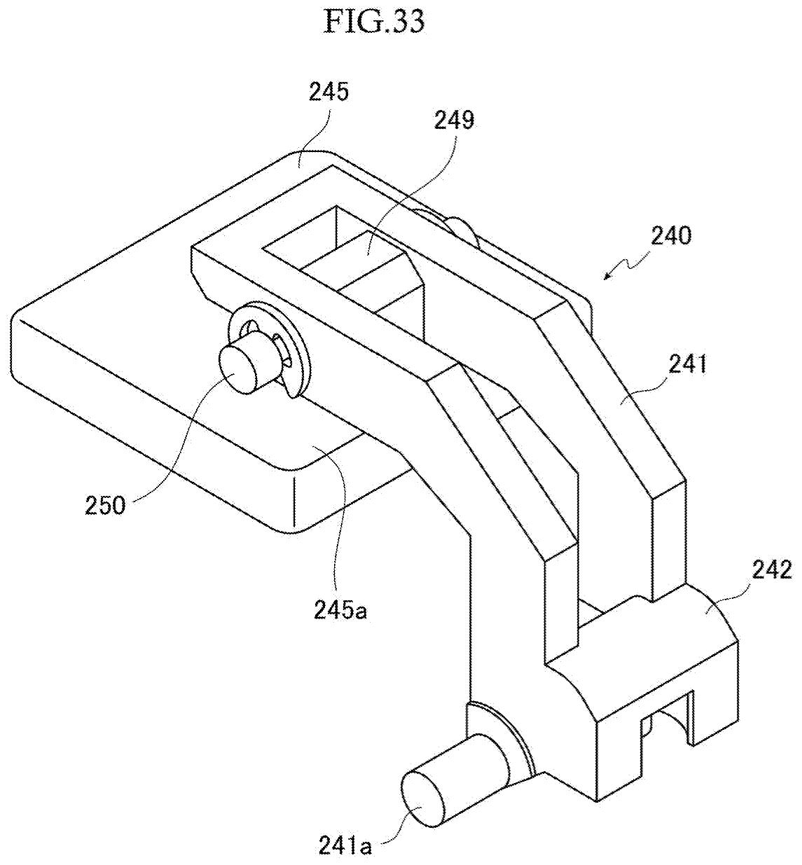

A latch 240 is provided in the socket body 220 of the IC socket 210. In this embodiment, the latch 240 shown in FIGS. 33-43 are provided on one side, as shown in FIGS. 28-32, but not on both sides as in the above-described embodiments 1, 2. The latch 240 includes a latch member body 241 which is pivotally mounted about a shaft 241a which is engaged in a predetermined position of the socket body 220 and a plate member 245 which is pivotally mounted to the latch member body 241.

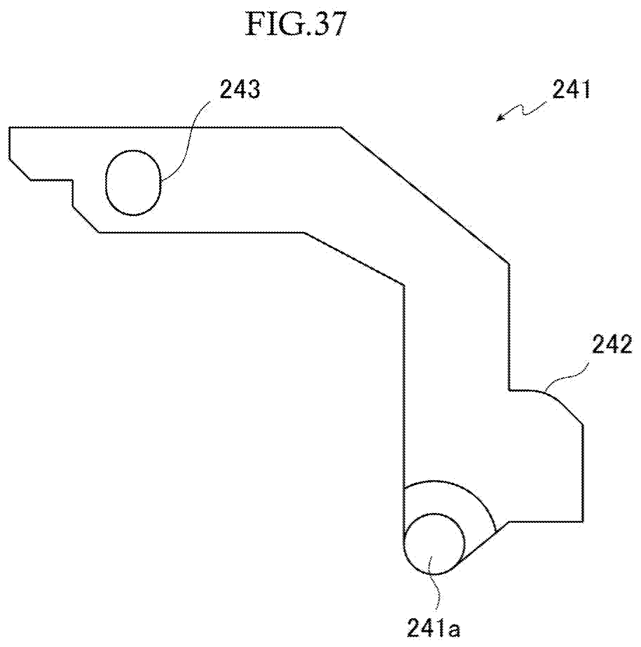

Of these, the latch member body 241 has a front view substantially L-shaped shape as shown in FIG. 37, and a long hole 243 is formed at the distal end. In the plate member 245, the bearing portion 249 is projected and the hole portion 249a is formed in the bearing portion 249.

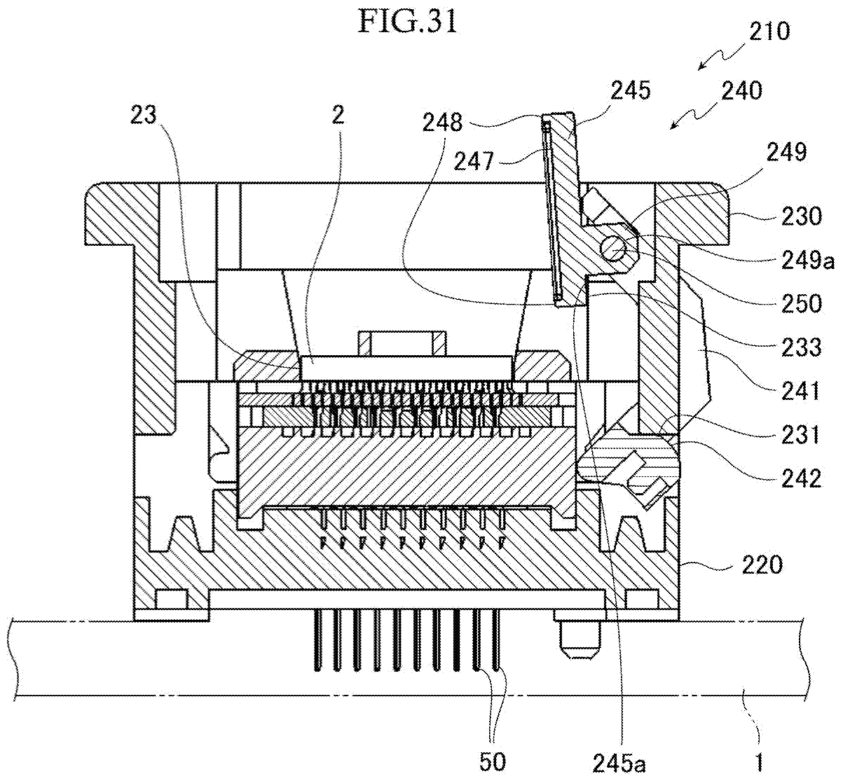

In addition, the plate member 245 is pivotally held with respect to the latch member body 241 while the shaft 250 penetrates the long hole 243 and the hole portion 249a. The shaft 250 has a diameter that is just inserted into the hole portion 249a of the bearing portion 249 and is configured to move a predetermined amount in a longitudinal direction relative to the long hole 243. As a result, the plate member 245 is rotatable with respect to the latch member body 241 and a predetermined amount of slide movement is possible. In addition, the bearing portion 249 is disposed at a predetermined offset position on the shaft 241a side of the latch member body 241 from the center position of the plate member 245. As shown in FIG. 31, the opening of the IC socket 210 can be largely gained when the latch 240 is opened, and thus the IC package 2 can easily be inserted.

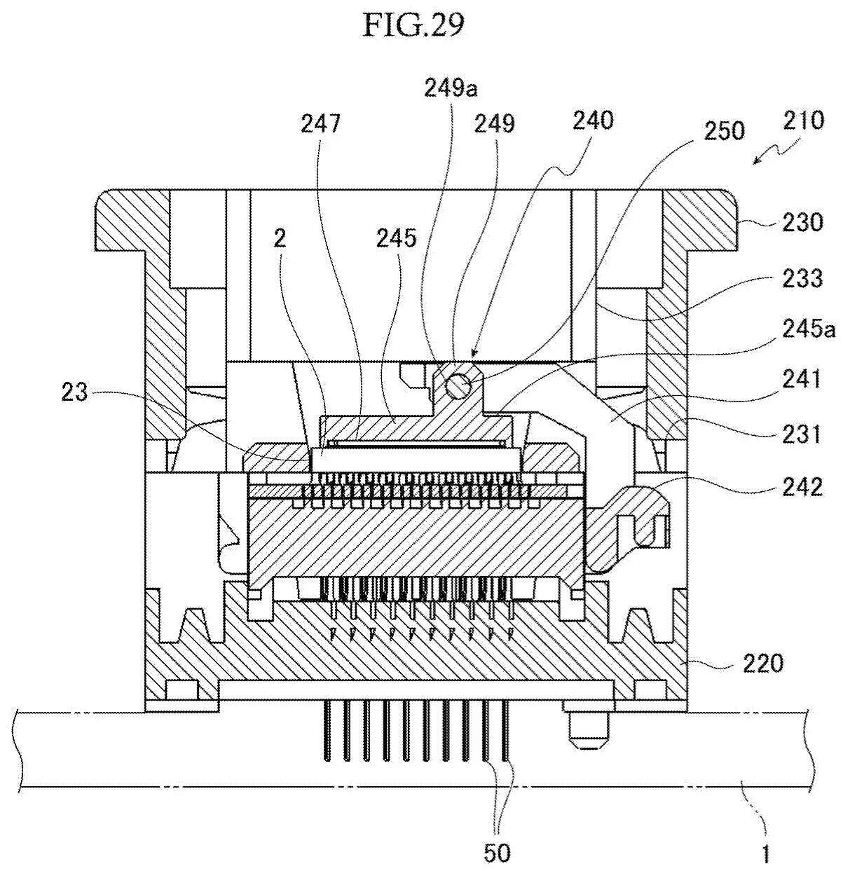

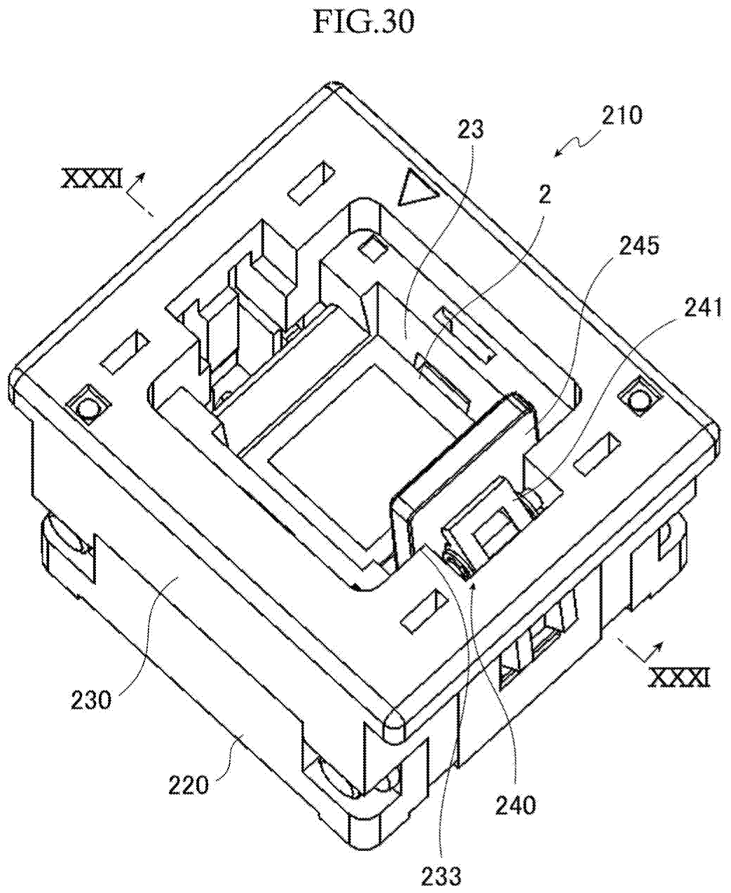

In addition, as shown in FIGS. 28 and 29, when the latch member body 241 is rotated inwardly by the biasing force of the biasing means (not shown), the plate member 245 pivotally mounted to the latch member body 241 is closed to push the IC package 2 contained in the housing portion 23. When the latch member body 241 is rotated outward against the biasing means, as shown in FIGS. 30 and 31, the plate member 245 mounted to the latch member body 241 is also evacuated from the housing portion 23 and the plate member 245 is configured to be open so as to release the pressurizing force of the IC package 2 housed in the housing portion 23 and to be removable.

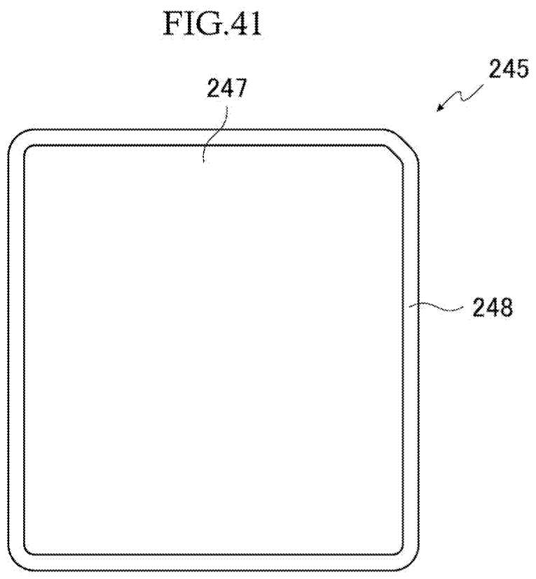

In addition, a flat-shaped covering portion 247 is provided on the plate member 245, and when the cover portion 247 is closed, the upper surface 5 of the package of the IC package 2 is covered with a predetermined clearance gap and is not in contact with the cover portion 247. Further, a protrusion portion 248 as a “pressing portion” is provided around the covering portion 247. Here, as shown in FIG. 41, substantially quadrilateral shaped protrusion portion 248 successively formed is protruded downwardly so as to cover the entire circumference of the covering portion 247 without any clearance. The protrusion portion 248 is configured to abut the resin member 6 around the upper surface 5 of the IC package 2.

Further, when the operating member 230 is pushed down, the latch member body 241 rotates outwardly, and accordingly, the plate member 245 is also evacuated outwardly. In this case, as shown in FIGS. 30 and 31, the edge 245a of the shaft 241a side of the plate member 245 abuts the wall surface 233 of the operation member 230, so that the plate member 245 rises and the housing member 23 opens widely.

Since the plate member 245 is rotatable with respect to the latch member body 241, the impact, which is received by the plate member 245 when the plate member 245 comes into contact with the IC package 2 from the front side of the latch member 241 and it hits one side of the IC package 2, may be reduced or not hit one side.

Next, the operation of the IC socket 210 of such configuration will be described.

First, as shown in FIGS. 30 and 31, the operating member 230 is pushed down against the biasing means to rotate the latch 240 outward to open the housing portion 23, and the IC package 2 is received in the housing portion 23 by an automatic machine or the like not shown.

Next, the pressing force of the operating member 230 is released and the operating member 230 is moved upward by the biasing force of the biasing means. The latch member body 241 then rotates inwardly. At this time, the plate member 245 also rotates inwardly to press the IC package 2. At this time, the protrusion portion 248 of the plate member 245 abuts the resin member 6 in the IC package 2 and covers the upper surface 5 of the package with the inner covering portion 247. Also, since the protrusion portion 248 are continuously constructed without any clearance, the upper surface 5 of the package and the outside air are shut off to prevent foreign matter from entering the package.

In this case, since the plate member 245 is rotatably configured with respect to the latch member body 241, the shaft 241a side of the plate member 245 does not hit one side when the IC package 2 is pressed by the plate member 245, or the shaft 241a side rotates after that even if it is hit by at least one side to reduce the impact. In addition, since the plate member 245 is held through the long hole 243, the plate member 245 does not hit the IC package 2 rapidly, and the plate member 245 is hit by the IC package 2 in a step-by-step manner. This further reduces the impact and prevents damage to the IC package 2.

In this state, the test is performed, and after the test, the operating member 230 is pushed down again to release the pressure to the IC package 2 by the latch 240, and to release the upper portion of the housing portion 23. The IC package 2 is removed by an automatic machine or the like in the present state.

According to this embodiment, since the covering portion 247 provided in the latch 240 covers the upper surface 5 of the IC package 2, it is possible to prevent foreign matter from being attached to the upper surface 5 of the IC package 2.

According to this embodiment, since the covering portion 247 of the latch 240 covers the upper surface 5 of the IC package 2, the IC package 2, which is extremely averse of foreign matter deposition on the upper surface 5 of the package, can be protected from foreign matter by the covering portion 247. In addition, since the protrusion portion 248 as the pressing portion of the latch 240 presses the portion consisting of the resin member 6 in the IC package 2, the protrusion portion 248, which is subject to force against the IC package 2, does not press the upper surface 5 of the package and is prevented from scratching the upper surface 5 of the package by the protrusion portion 248.

Further, according to this embodiment, the latch 240 includes the latch member body 241 and the plate member 245 mounted thereto, and the protrusion portion 248 is provided around the plate member 245, and the covering portion 247 is provided inside the plate member 245. Therefore, the upper surface 5 of the IC package 2 can be covered with one latch 240 without any clearance, thereby making it difficult to attach any foreign matter.

Further, according to this embodiment, since the pressing portion of the latch 240 is composed of the protrusion portion 248, the gap between the latch 240 and the IC package 2, when the IC package 2 is pressed by the protrusion portion 248, can be eliminated as much as possible, thereby protecting the foreign matter from entering the inside from the lateral direction.

### Embodiment 4 of the Invention

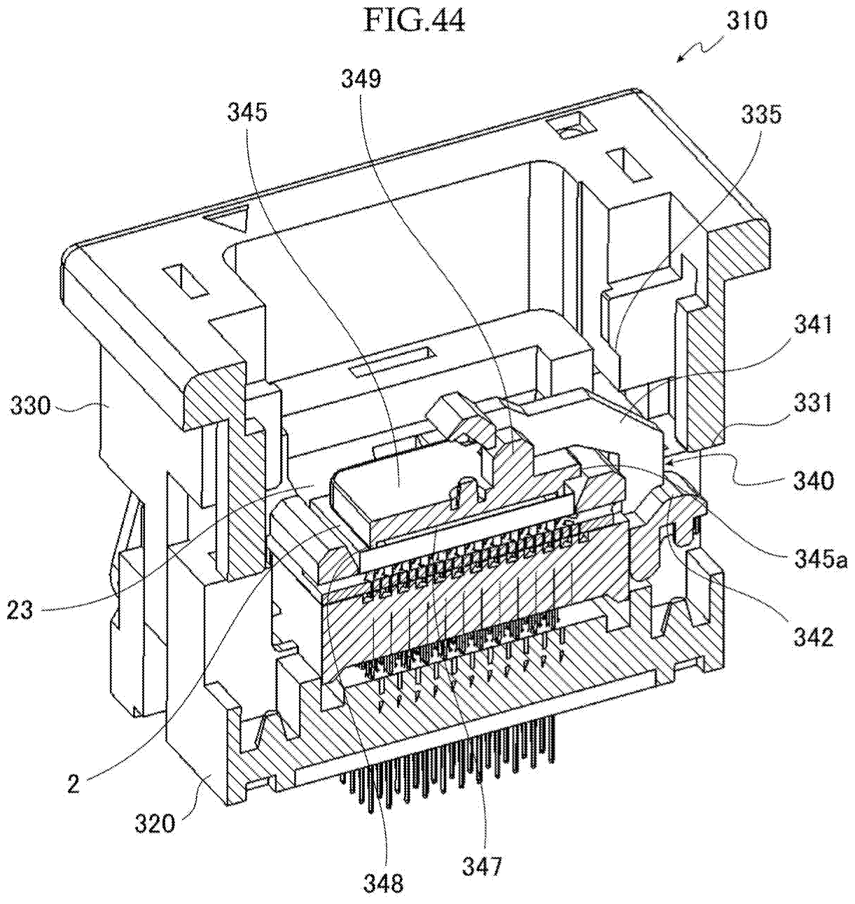

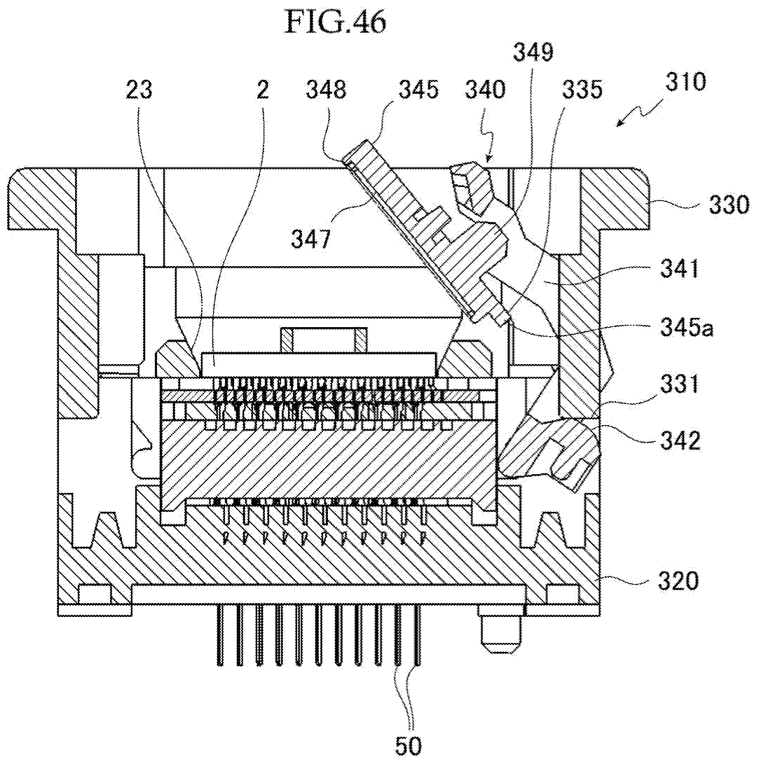

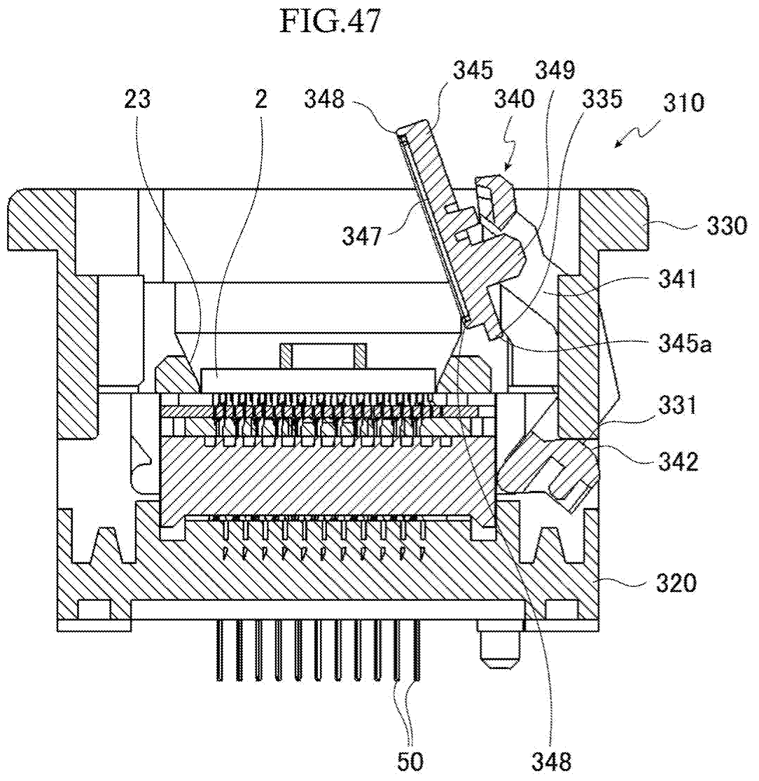

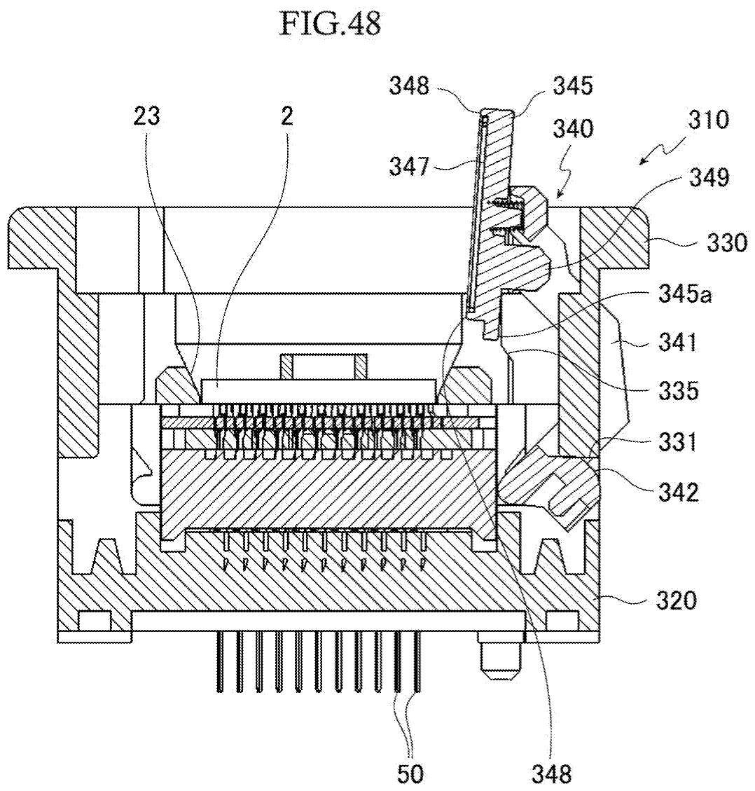

FIGS. 44-48 show embodiment 4 of the present invention. Since the embodiment of the invention are the same as those of the above-described embodiment 3 with respect to matters other than those described below, the description is omitted except for matters that are different from the above-described embodiment 3.

The socket body 320 of the IC socket 310 is provided with a latch 340. The latch 340 of this embodiment is provided on one side as shown in FIGS. 44-48.

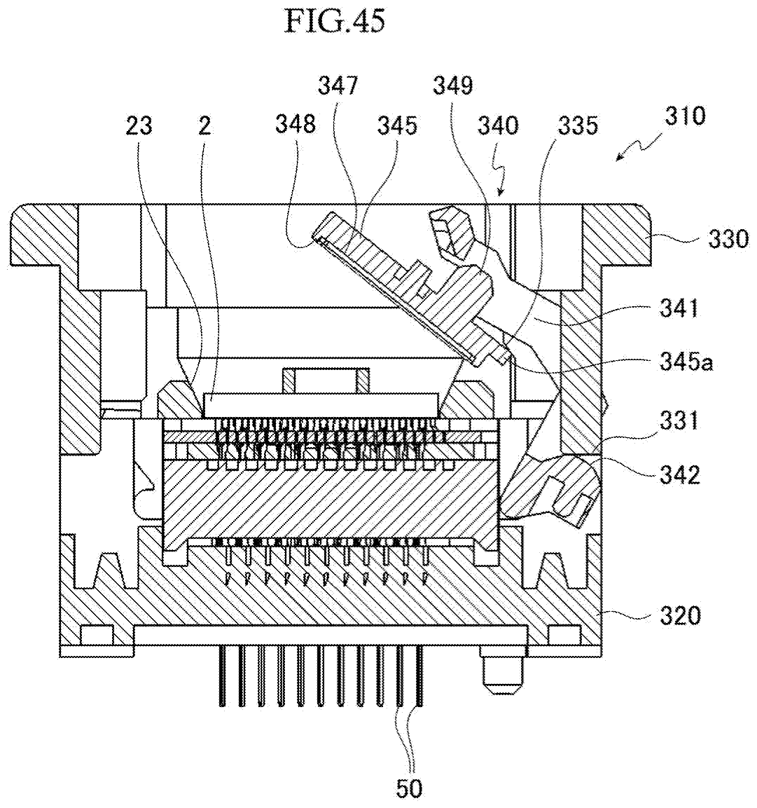

The axial end of the latch member body 341 of the plate member 345 has a contact portion 345a projecting on the front side (the right side of FIG. 45). As the latch 340 rotates outwardly, the contact portion 345a abuts the abutment portion 335 of the operating member 330.

The abutment portion 335 is formed at the position where the contact portion 345a of the plate member 345 comes into contact with the operating member 330. The abutment portion 335 is a wall portion which is inclined inwardly from a lower side to an upper side. The contact portion 345a contacts the abutment portion 335 and rotates outwardly as it is, so that the plate member 345 is pressed along the rotation and the contact portion 345a stands up smoothly. As a result, the housing portion 23 can be opened in a smooth manner when the housing portion 23 is opened.

According to this embodiment, since the covering portion 347 provided in the latch 340 covers the upper surface 5 of the IC package 2, foreign matter can be difficult to attach to the upper surface 5 of the IC package 2.

According to this embodiment, since the covering portion 347 of the latch 340 covers the upper surface 5 of the IC package 2, the IC package 2, which is extremely averse of foreign material adhering to the upper surface 5 of the package, can be protected from foreign material by the covering portion. In addition, since the protrusion portion 348 as the pressing portion of the latch 340 presses the portion made of the resin member 6 in the IC package 2, the protrusion portion 348 does not press the upper surface 5 of the package and the upper surface 5 of the package is prevented from being scratched by the protrusions.

Further, according to this embodiment, the latch 340 includes the latch member body 341 and the plate member 345 mounted thereon, and the protrusion portion 348 is provided around the plate member 345, and the covering portion 347 is provided inside the protrusion portion 348. Therefore, even one of the latch members can cover the upper surface 5 of the IC package 2 without any clearance, thereby making it difficult to attach any foreign matter.

Further, according to the present embodiment, since the pressing portion of the latch 340 is composed of the protrusion portion 348, the gap between the latch 340 and the IC package 2 when the IC package 2 is pressed on the protrusion portion 348 can be eliminated as much as possible, so that foreign matter does not enter from the lateral direction.

Further, according to this embodiment, the contact portion 345a of the latch 340 and the abutment portion 335 of the operating member 330 enable the plate member 345 to stand up smoothly, so that the housing portion 323 in the open state can be smoothly and widely opened.

It should be noted that the “socket for electrical component” of the present invention are not limited to structures such as the above described embodiments, but are also applicable to other structures such as other devices other than IC sockets.

Further, the shape of the protrusion portion may be such that the cross-section is square and the pressing surface is flat, the cross-section is triangular and the surface pressure of the pressing surface is raised, or the front end of the cross-section is circular in shape so that the resin member 6 of the IC package 2 is pressed in a frame shape without any clearance.

Further, the material of the protrusion portion may be not only a hard resin, but also a flexible, soft resin, or silicone rubber.

### EXPLANATION OF REFERENCES

1 wiring substrate
2 IC package (electrical component)
4 solder ball (terminal)
5 upper surface of the package
6 resin member
10, 110,2 10, 310 IC socket (socket for electrical component)
20, 120, 220, 320 socket body
23 housing portion
30, 130, 230, 330 operating member
31, 32, 131, 132, 231, 331 pushing portion
40, 140, 240, 340 latch
41, 141 first latch member
41a, 45a, 141a, 241a shaft
42, 46, 142, 146, 242, 342 pushed portion
43, 47, 143, 147, 247, 347 covering portion
43a, 47a, 143a, 147a tip portion
44, 48, 144, 148, 248, 348 protrusion portion (pressing portion)
45, 145 second latch member
49 contact portion
50 contact pins
233 wall surface
245a edge
241, 341 latch member body
243 long hole
245, 345 plate member
249, 349 bearing portion
249a hole portion
250 shaft
335 abutment portion
345a contact portion

1. A socket for electrical component comprising: a socket body having a housing portion for housing an electrical component, a contact pin electrically connected to a terminal of the electrical component, a latch for pressing the electrical component in a closed state while an opening/closing operation is performed, and an operating member, movable up/down with respect to the socket body, for actuating the latch,
wherein the latch is provided with a pressing portion for pressing the electrical component and a covering portion covering a predetermined portion of the electrical component.

2. The socket for electrical component according to claim 1, wherein the latch includes a first latch member and a second latch member that are movably disposed about an axis facing both sides of the housing portion,
the first latch member and the second latch member are provided with the pressing portion and the covering portion respectively, and
when the first latch member and the second latch member are in the closed state, a distal end portion of the covering portion of the first latch member and a distal end portion of the covering portion of the second latch member overlap so that a predetermined portion of the electrical component is covered by both of the covering portions.

3. The socket for electrical component according to claim 1, wherein the latch includes a first latch member and a second latch member that are movably disposed about an axis facing both sides of the housing portion,
the first latch member and the second latch member are provided with the pressing portion and the covering portion respectively, and
when the first latch member and the second latch member are in the closed state, a distal end portion of the covering portion of the first latch member and a distal end portion of the covering portion of the second latch member are in contact each other so that a predetermined portion of the electrical component is covered by both of the covering portions.

4. The socket for electrical component according to claim 1, wherein the latch includes a latch member body which is movably disposed about an axis with respect to the socket body and a plate member which is pivotally mounted to the latch member body, and
the plate member is provided with the pressing portion around the plate member and has the covering portion inside the pressing portion.

5. The socket for electrical component according to claim 4, wherein
a contact portion is provided at an end of the plate member of the axis side of the latch member body,
an abutment portion configured to be inclined inward from a lower side to an upper side of the socket body is provided at a position where the contact portion contacts when the latch moves from the closed state to an open state in the opening/closing operation, and
when the latch is moved from the closed state to the open state in the opening/closing operation, the contact portion moves along the abutment portion, such that the plate member pivots with respect to the latch member body to be a rising state with respect to the socket body and the housing portion is configured to open toward upward.

6. The socket for electrical component according to claim 1, wherein the pressing portion of the latch is composed of a protrusion portion and is configured to surround the covering portion.
